(19) United States
(12) Patent Application Publication
(10) Pub. No.: US 2024/0375505 A1
(43) Pub. Date: Nov. 14, 2024

(54) All-Terrain Vehicle

(71) Applicant: Zhejiang CFMOTO Power Co., Ltd., Hangzhou (CN)

(72) Inventors: Chao Wang, Hangzhou (CN); Longping Luo, Hangzhou (CN); Zhibin Cao, Hangzhou (CN); Meng Chen, Hangzhou (CN); Jianrong Tian, Hangzhou (CN); Zhenhu Xing, Hangzhou (CN)

(21) Appl. No.: 18/783,698

(22) Filed: Jul. 25, 2024

Related U.S. Application Data
(63) Continuation of application No. PCT/CN2022/073887, filed on Jan. 25, 2022.

(51) Int. Cl. B60K 13/02; B60R 13/08; B62D 21/11; B62D 25/10; B62D 25/18; B62J 1/28

(52) U.S. Cl. CPC B60K 13/02; B60R 13/08; B62D 21/11; B62D 25/10; B62D 25/18; B62J 1/28

(57) ABSTRACT

An all-terrain vehicle includes a frame, a vehicle cover, a plurality of wheels, a suspension, a prime mover assembly with an engine and a transmission, and an intake system. The intake system includes an air inlet on an instrument shield providing cooling air to the transmission. The instrument shield windward surface extends transversely, upwardly and rearwardly at an angle to horizontal in the range of 45 to 90 degrees. The vehicle cover includes left and right side cover assemblies each with insulation covers. The prime mover assembly is in an accommodation space extending inside of the left and right insulation covers, substantially isolated from contact with the left and right insulation covers by airflow within the accommodation space. Flow-guiding cavities are defined adjacent wind-in surfaces on the underside(s) of left and/or right front fenders, and the flow-guiding cavities introduce airflow into the accommodation space.

### RELATED APPLICATION INFORMATION

The present application is a continuation of and claims the benefits of priority to International Application Number PCT/CN2022/073887, filed on Jan. 25, 2022. The entire contents of the above-referenced application are incorporated herein by reference.

### FIELD OF THE DISCLOSURE

The disclosure relates to the field of vehicles, and particularly to all-terrain vehicles.

### BACKGROUND OF THE DISCLOSURE

In most existing all-terrain vehicles (ATVs), heat generated from a transmission and an engine is mainly discharged by a radiator. However, the heat dissipation effect of the radiator may be not enough, which causes heat to be discharged slowly, so the temperature inside the ATV will be too high, thereby affecting the service life of the vehicle and comfort for the driver.

In addition, there is generally no corresponding heat dissipation mechanism like the radiator for the muffler of the ATVs to dissipate heat. The uncooled muffler can result in an increase in the temperature of plastic covers around and/or above the muffler, which poses a safety hazard to the driver. Therefore, there is a need for better layout and/or a method to dissipate heat from the muffler and any plastic covers around and/or above it, in order to improve the heat dissipation effect of the muffler and plastic covers.

In existing ATVs, the engine and other components that generate significant heat are generally mounted in a riding area, which also poses a safety hazard to the driver. Further, components such as the engine can produce significant noise. Therefore, there is a need for a method to improve the internal ventilation efficiency of ATVs, to achieve better heat dissipation and reduce noise during driving, while still providing better vehicle layout. Many other issues with existing ATVs can be simultaneously solved, particularly associated mounting of various components to the frame and with which components are fixed to the frame so as to be easily detachable.

### SUMMARY OF THE INVENTION

In view of this, the present application provides an all-terrain vehicle (ATV) with good heat dissipation effect and reduced noise, and which simultaneously solves other issues.

The present invention is an ATV. The ATV includes a frame, a vehicle cover, wheels, a suspension, a prime mover assembly, and an intake system. The vehicle cover is at least partially arranged on the frame. The vehicle cover defines an accommodation space around the prime mover assembly. The vehicle cover also includes an instrument shield. The wheels include two front wheels and two rear wheels. The suspension includes a front suspension and a rear suspension. The front wheels are connected to the frame by the front suspension and the rear wheels are connected to the frame by the rear suspension. The prime mover assembly includes an engine and may also include a transmission. The engine provides torque which drives the wheels through the transmission. The intake system is in fluid communication with the prime mover assembly. The intake system further includes an air inlet at least partially defined on the instrument shield and an air intake pipe connected to the transmission. The air inlet is in fluid communication with the air intake pipe. The vehicle cover further includes left and right side cover assemblies each with insulation covers. The accommodation space extends inside of the left and right insulation covers from a front of frame to a rear of frame, with the prime mover assembly being substantially isolated from contact with the left and right insulation covers by airflow within the accommodation space.

In another aspect, the instrument shield has an instrument shield windward surface facing forwardly, and the air inlet is on the instrument shield windward surface. The instrument shield windward surface extends transversely, upwardly and rearwardly at an angle to horizontal in the range of 45 to 90 degrees.

In another aspect, a plurality of flow-guiding cavities are defined adjacent wind-in surfaces on the underside(s) of the left and/or right front fenders. The flow-guiding cavities receive air off a windward side of a footwell. The flow-guiding cavities introduce airflow into the accommodation space, which can help cool the prime mover assembly and the exhaust system for the engine.

### BRIEF DESCRIPTION OF THE DRAWINGS

FIG. 1 is a rear left perspective view of an all-terrain vehicle (ATV) of the present invention.

FIG. 2 is a side view of the ATV of FIG. 1.

FIG. 3 is a front left perspective view of a prime mover assembly used in the ATV of FIGS. 1 and 2.

FIG. 4 is a simplified rear left perspective view of a frame used in the ATV of FIGS. 1 and 2.

FIG. 5 is a rear left perspective view of the simplified frame body of FIG. 4, but also showing a front saddle mounting bracket of the frame body and a saddle.

FIG. 6 is an enlarged view of part A of FIG. 5.

FIG. 7 is a bottom view of the saddle of FIG. 5.

FIG. 8 is a rear left perspective view of the simplified frame body of FIG. 4, but also showing a rear saddle mounting bracket of the frame body.

FIG. 9 is an exploded rear left perspective view of the rear saddle mounting bracket of FIG. 8.

FIG. 10 is a rear left perspective view of the simplified frame body of FIG. 4, but also showing a towing bracket.

FIG. 11 is an exploded rear left perspective view of the towing bracket of FIG. 10.

FIG. 12 is a side view of the simplified frame of FIG. 4 and two shelves.

FIG. 13 is a plan view of one of the shelves of FIG. 12.

FIG. 14 is a plan view of the shelf body perimeter tube and reinforcement tubes of the shelf of FIGS. 12 and 13.

FIG. 15 is a rear perspective view of the shelf of FIGS. 12 and 13 together with a backrest and a backrest mounting seat.

FIG. 16 is a front left perspective view of the backrest of FIG. 15.

FIG. 17 is a cross-sectional view of the backrest of FIGS. 15 and 16, taken along cut lines 17-17 of FIG. 16.

FIG. 18 is a rear left perspective view of the simplified frame body of FIG. 4, but also showing the prime mover assembly in a cradle.

FIG. 19 is an exploded left perspective view of the cradle of FIG. 18.

FIG. 20 is a perspective view of one of the buffers of FIG. 19.

FIG. 21 is a rear left perspective view of the simplified frame body of FIG. 4, but also showing a cylinder head support.

FIG. 22 is an enlarged view of part B of FIG. 21.

FIG. 23 is a front left perspective view of the simplified frame body of FIG. 4, but also showing a winch and winch mount plate.

FIG. 24 is a side view of the simplified frame body of FIG. 4, but also showing a winch relay and winch relay mounting bracket.

FIG. 25 is an enlarged view of part C of FIG. 24.

FIG. 26 is a left perspective view of the simplified frame body of FIG. 4, but also showing a license plate holder.

FIG. 27 is a perspective view of the license plate holder of FIG. 26.

FIG. 28 is a rear left perspective view of a front bumper and a portion of the front brace of FIG. 4.

FIG. 29 is a left side view of the simplified frame of FIG. 4, but also showing simplified wheels and the fuel system of the ATV of FIGS. 1 and 2.

FIG. 30 is a rear right perspective view of portions of the fuel system of FIG. 29.

FIG. 31 is a view of an insulation pad used with the fuel tank of FIGS. 29 and 30.

FIG. 32 is a rear perspective view of the fuel tank of FIGS. 29 and 30.

FIG. 33 is an enlarged view of part D of FIG. 32.

FIG. 34 is a side view of a gearshift used in the ATV of FIGS. 1 and 2.

FIG. 35 is a cross-sectional view of the shift handle of the gearshift assembly of FIG. 34.

FIG. 36 is an enlarged view of part E in FIG. 1, providing a rear left perspective view of the gearshift assembly of FIG. 34

FIG. 37 is a right perspective view of the braking system on the frame body of the ATV of FIGS. 1 and 2.

FIG. 38 is a plan view of a tee connector used in the braking system of FIG. 37.

FIG. 39 is a rear left perspective view of a handlebar and handlebar fixing blocks used in the steering assembly for the ATV of FIGS. 1 and 2.

FIG. 40 is a side view of one of the handlebar fixing blocks of FIG. 39.

FIG. 41 is a left perspective view of the simplified frame body of FIG. 4, but also showing an EPS module and EPS mounting brackets.

FIG. 42 is a side view of the exhaust system used in the ATV of FIGS. 1 and 2.

FIG. 43 is a perspective view of the muffler and an insulation cover of the exhaust system of FIG. 42.

FIG. 44 is a front left perspective view of a portion of the vehicle cover used in the ATV of FIGS. 1 and 2.

FIG. 45 is a right side view of the air intake system used in the ATV of FIGS. 1 and 2 relative to a portion of the simplified frame body of FIG. 4.

FIG. 46 is a left side view of the cooling system and a nosepiece of the vehicle cover used in the ATV of FIGS. 1 and 2.

FIG. 47 is a front left perspective view of the nosepiece and cooling system of FIG. 46.

FIG. 48 is a right side view of a portion of the cooling system of FIGS. 46 and 47.

FIG. 49 is a right perspective view of a portion of the cooling system of FIGS. 46 and 47.

FIG. 50 is an upwardly-looking rear left perspective view of a portion of the cooling system of FIGS. 46 and 47 as mounted relative to a portion of the frame of FIG. 4.

FIG. 51 is cross section view of the hose support clamp used to mount the coolant hoses of the cooling system of FIGS. 46, 47, 49 and 50.

FIG. 52 is an upwardly-looking front right perspective view of portions of the vehicle cover used on the ATV of FIGS. 1 and 2.

FIG. 53 is an upwardly-looking front left perspective view of the portions of the vehicle cover shown in FIG. 52.

FIG. 54 is an exploded front left perspective view of the front fenders, front maintenance chamber and front maintenance cover of the vehicle cover of the ATV of FIGS. 1 and 2.

FIG. 55 is a cross-sectional side view of the assembled front maintenance cover on the front maintenance chamber of FIG. 54 taken at cut line 55-55, and further showing the instrument shield of the vehicle cover of the ATV of FIGS. 1 and 2.

FIG. 56 is an exploded front left perspective view of the rear fenders and rear maintenance cover of the vehicle cover of the ATV of FIGS. 1 and 2.

FIG. 57 is a cross-sectional side view of the assembled rear maintenance cover on the rear fenders of FIG. 56 taken at the longitudinal mid-plane, and further showing the ECU.

FIG. 58 is a rear left perspective view of a tail panel and trunk compartment of the ATV of FIGS. 1 and 2.

FIG. 59 is a cross-section side view of the tail panel and trunk compartment of FIG. 58, taken at cut line 59-59.

FIG. 60 is a right side view of the ATV of FIGS. 1 and 2, without showing the wheels.

FIG. 61 is a left side view of the ATV of FIGS. 1 and 2, without showing the wheels.

FIG. 62 is an exploded rear right perspective view of the left footwell and left side cover assembly of the vehicle cover of the ATV of FIGS. 1 and 2.

FIG. 63 is an exploded rear left perspective view of the front fenders, right footwell and right side cover assembly of the vehicle cover of the ATV of FIGS. 1 and 2.

FIG. 64 is a cross-sectional side view of portions of the vehicle cover of the ATV of FIGS. 1 and 2 including the fuel tank guard, taken at the longitudinal mid-plane.

FIG. 65 is a top plan view of portions of the vehicle cover of the ATV of FIGS. 1 and 2.

FIG. 66 is a front left perspective view of the nosepiece and front grille of the ATV of FIGS. 1 and 2.

FIG. 67 is a rear left perspective view of the front grille of FIG. 66.

### DETAILED DESCRIPTION

The following will provide a detailed description of the present invention in conjunction with the specific embodiment shown in the accompanying drawings, but the embodiment shown and the embodiments discussed do not limit the present invention.

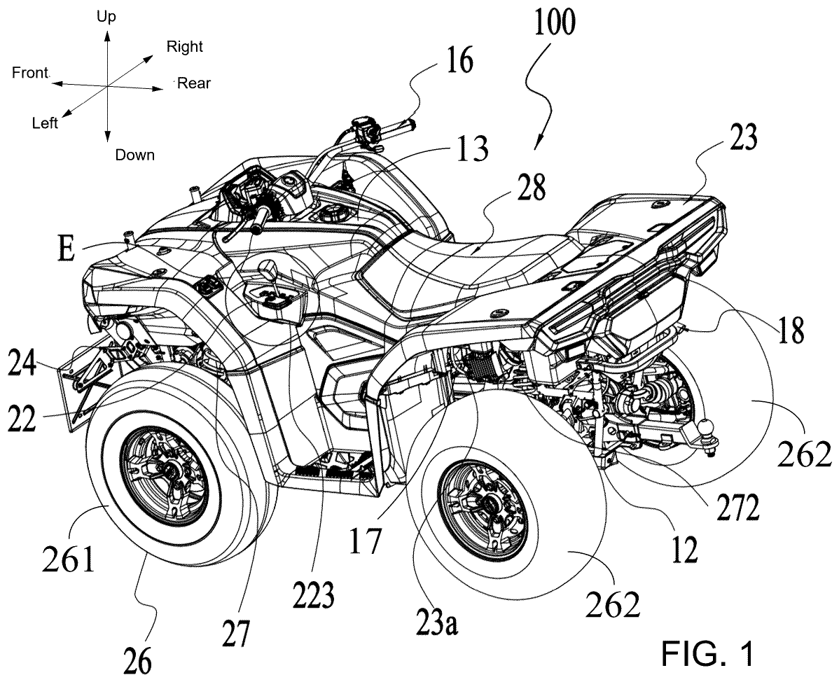

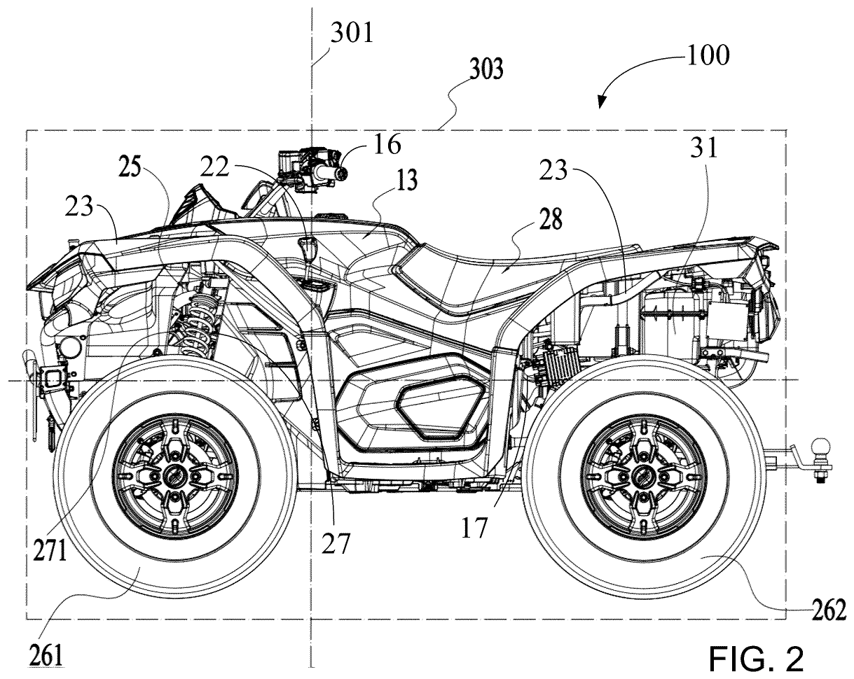

As shown in FIGS. 1 and 2, an all-terrain vehicle (ATV) 100 includes a frame 12, a fuel system 13, a steering assembly 16, an electrical system 17, an exhaust system 18, a gearshift assembly 22, a vehicle cover 23, a collection of mounting brackets 24, an intake system 25, a plurality of wheels 26, a suspension 27, and a saddle assembly 28. The frame 12 supports the steering assembly 16, the exhaust system 18, and the vehicle cover 23. The collection of mounting brackets 24 are mounted to the frame 12. The steering assembly 16 controls the running direction of front wheels 261. The exhaust gas generated during the running of the ATV 100 is discharged to the external environment through the exhaust system 18. The gearshift assembly 22 is arranged on the frame 12 and connected to the vehicle cover 23. The wheels 26 are connected to the frame 12 by the suspension 27. The general orientations of front, rear, up (upper), down (lower), left and right for the ATV 100 are defined in FIG. 1 for clarity. The terms “up”, “down” “vertical”, “horizontal”, etc. used herein assume the vehicle wheels are on a flat, horizontal surface, i.e., not on a slope, and with the wheel/tire sizes depicted.

The wheels 26 include two front wheels 261 and two rear wheels 262. Both the front wheels 261 and/or the rear wheels 262 may be driven to move the ATV 100. The front wheels 261 are connected to the steering assembly 16, so that the steering assembly 16 can control the running direction of the front wheels 261 to turn the ATV 100. The suspension 27 includes a front suspension 271 called out in FIG. 2 and a rear suspension 272 called out in FIG. 1, with the front wheels 261 connected to frame 12 by the front suspension 271 and the rear wheels 262 connected to frame 12 by the rear suspension 272.

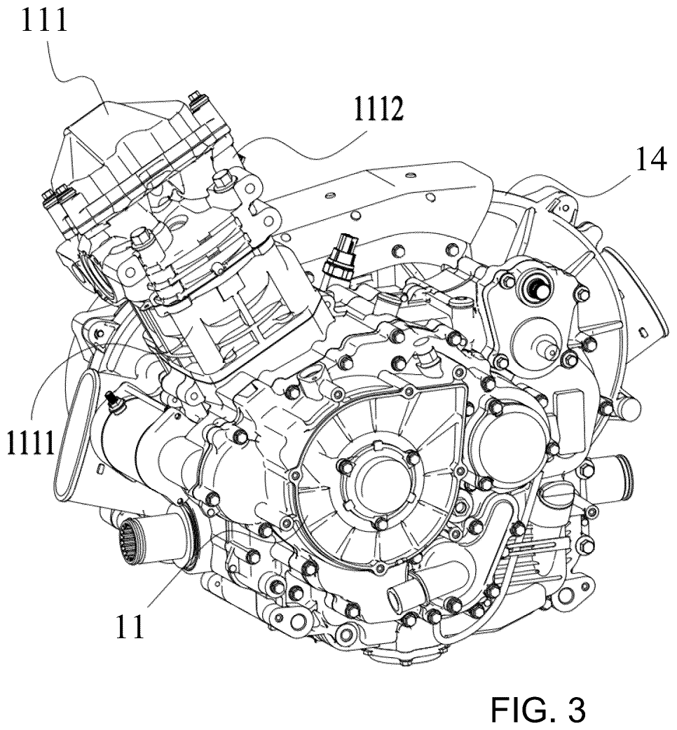

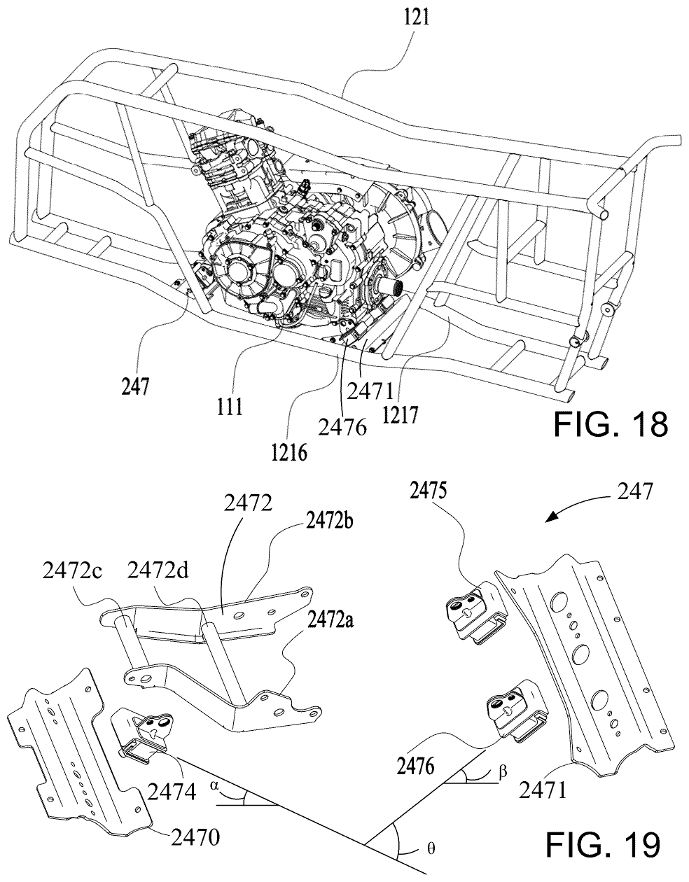

The all-terrain vehicle 100 includes a prime mover assembly 11 shown in FIGS. 3 and 18. The prime mover assembly 11 is mounted on the frame 12 and provides torque for locomotion of the ATV 100. An accommodation space 23a (see FIG. 1) is defined which runs longitudinally between the prime mover assembly 11 and the vehicle cover 23. The prime mover assembly 11 includes an engine 111 coupled to a transmission 14 (further shown in FIG. 45). The transmission 14 can change the rotational speed output by the prime mover assembly 11 relative to the rotational speed output by the engine 111, and thereby change the running speed of the ATV 100. The engine 111 includes at least one cylinder 1111 and a cylinder head 1112 positioned at a top end of the cylinder 1111. The cylinder 1111 is equipped with a combustion chamber and piston assembly (not shown), and the combustion chamber is connected to the intake system 25 and the exhaust system 18. In preferred embodiments, the transmission 14 is a continuously variable transmission (CVT). The transmission 14 may alternatively be an automatic transmission (AT), a dual clutch transmission (DCT), or the like.

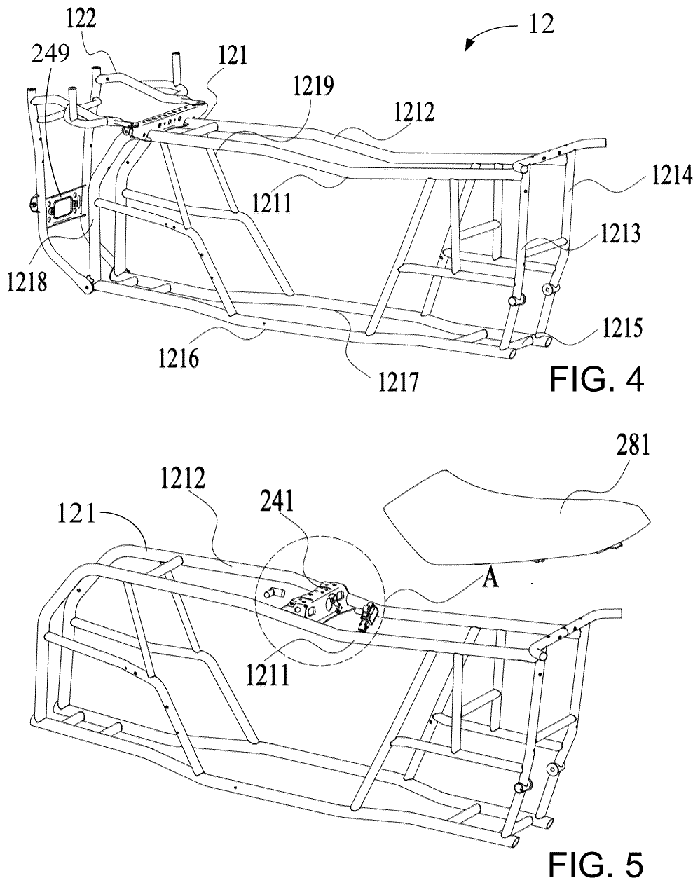

FIG. 4 shows a generalized or simplified view of the frame 12. The frame 12 includes a frame body 121 and a front brace 122 both formed of metal. The frame body 121 includes a top left main beam 1211, a top right main beam 1212, a rear left upright 1213, a rear right upright 1214, a rear base crossbeam 1215, a left base beam 1216, a right base beam 1217, two front uprights 1218, and two front angled support beams 1219. The frame body 121 may be made by welding of tubular elements. The front brace 122 is connected in front of the frame body 121 such as by bolts 1221. The front brace 122 can extend the overall length and/or height of the frame 12 as an extension of the frame body 121, allowing the frame 12 to support more components.

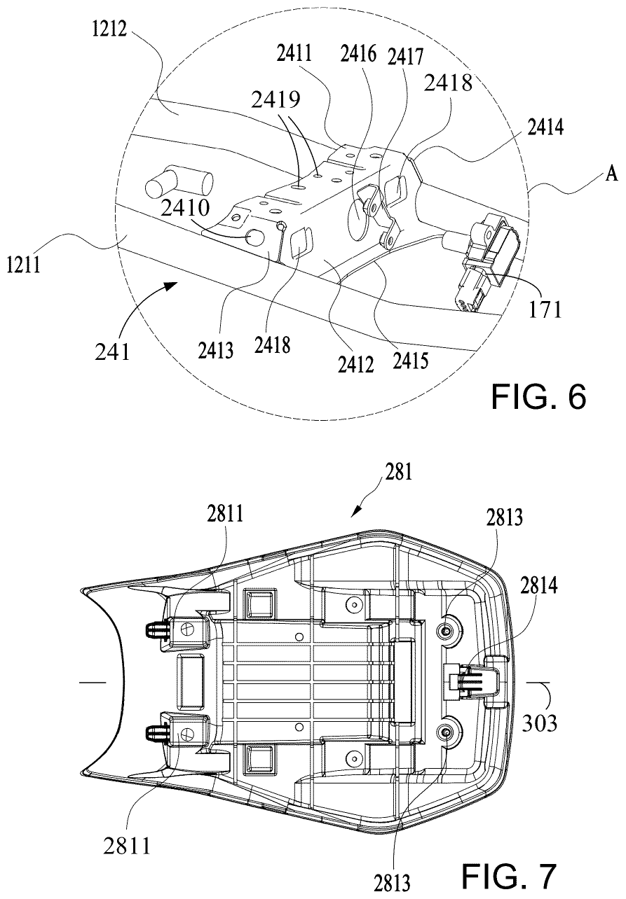

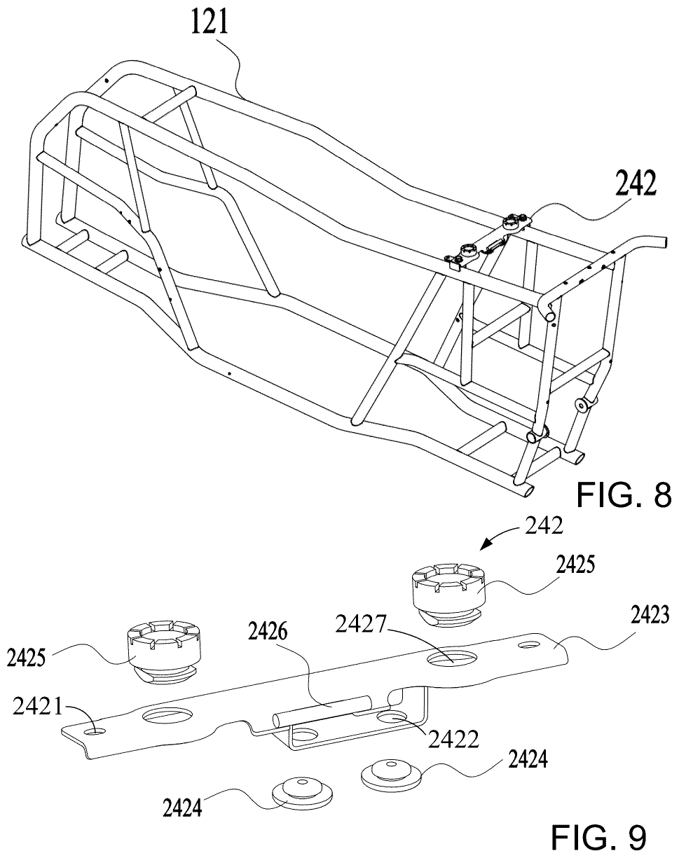

As shown in FIGS. 5, 8, 10, 12, 18, 21, 23, 24 and 26, the collection of mounting brackets 24 are mounted on the frame body 121. The collection of mounting brackets 24 includes a front saddle mounting bracket 241 shown in FIGS. 5 and 6 and a rear saddle support bracket 242 shown in FIGS. 8 and 9. The saddle assembly 28 includes a saddle 281 shown in FIGS. 5 and 7. The saddle 281 is connected at least partially between the front saddle mounting bracket 241 and the rear saddle support bracket 242.

As shown in FIG. 5 and FIG. 6, the front saddle mounting bracket 241 is mounted on the frame body 121. The front saddle mounting bracket 241 is positioned to extend from the top left main beam 1211 to the top right main beam 1212, connected at its ends to the top left main beam 1211 and to the top right main beam 1212. The front saddle mounting bracket 241 includes a top surface 2411, a rear sidewall 2412, a left sidewall 2413, a right sidewall 2414, and a bottom flange 2415 extending parallel to the top surface 2411. The rear sidewall 2412 extends generally perpendicular to the top surface 2411 and is connected to the bottom flange 2415. The left sidewall 2413 and the right sidewall 2414 are both connected to the rear sidewall 2412. As called out in FIGS. 2, 7, 60 and 65, a longitudinal mid-plane 303 is defined as a vertical plane where a center line of the vehicle 100 in a width direction is positioned. The left sidewall 2413 and the right sidewall 2414 are substantially symmetrical with respect to the longitudinal mid-plane 303. A plurality of mounting holes 2419 are distributed on the top surface 2411, which can be used such as for fixing elements of the fuel system 13 and/or for fixing elements of the intake system 25. Mounting holes 2410 are defined on both the left sidewall 2413 and the right sidewall 2414, which can be used as mounting points for fixing the vehicle cover 23. The front saddle mounting bracket 241 may be manufactured by stamping and bending sheet metal, which can reduce manufacturing costs and improve production efficiency.

The rear sidewall 2412 defines a protective hole 2416 for protecting an ignition coil 171, and a limiting member 2417 is used to secure the ignition coil 171 so that the ignition coil 171 is fixed inside the protective hole 2416. The front saddle mounting bracket 241 can protect the ignition coil 171, so that the ignition coil 171 will not interfere with other components. The front saddle mounting bracket 241 provides a reliable mounting position for the ignition coil 171, and can also prevent collisions between the ignition coil 171 and the frame 12 or other components caused by bumps during the running of the ATV 100, which improves the utilization rate of internal space of the ATV 100 and optimizes the spatial layout of the ATV 100.

The rear sidewall 2412 also defines left and right saddle mounting holes 2418 for docking with the saddle 281. As shown in FIG. 7, the lower surface of the saddle 281 includes left and right insertion parts 2811. The left and right saddle mounting holes 2418 and the left and right insertion parts 2811 are both substantially symmetrical with respect to the longitudinal mid-plane 303. To connect the saddle 281 to the front saddle mounting bracket 241, the left and right insertion parts 2811 are inserted forwardly into the corresponding left and right saddle mounting holes 2418 before pivoting the rear of the saddle 281 downwardly to mate into the rear saddle support bracket 242.

As shown in FIGS. 8 and 9, the rear saddle support bracket 242 is positioned toward the rear of the ATV 100, extending between the top left main beam 1211 and the top right main beam 1212. The rear saddle support bracket 242 is positioned a distance behind the front saddle mounting bracket 241 which generally corresponds with the length of the saddle 281. In some embodiments, the rear saddle support bracket 242 is mounted on the frame body 121 by bolts (not shown) through bolt holes 2421. The rear saddle support bracket 242 includes a mounting bracket body 2423, bottom bumpers 2424, top bumpers 2425, and a fixing crosspin 2426. The bottom bumpers 2424 are mounted on the mounting bracket body 2423, such as by compressibly squeezing through bottom bumper mounting holes 2422 on the mounting bracket body 2423. The bottom bumpers 2424 can be used such as to connect components (not shown) of the electrical system 17, thereby limiting shaking of such components in the up-down direction. The top bumpers 2425 are similarly mounted on the mounting bracket body 2423, such as by compressibly squeezing through top bumper mounting holes 2427 on the mounting bracket body 2423.

The top bumpers 2425 provide support points for the saddle 281, thereby facilitating the connection between the saddle 281 and the frame 12. As shown in FIG. 7, support surfaces 2813 are arranged on the lower surface of the saddle 281. The support surfaces 2813 are positioned behind the left and right insertion parts 2811. The support surfaces 2813 are clamped against the top bumpers 2425 to set the elevation of the saddle 281 relative to the rear saddle support bracket 242. The bottom bumpers 2424 and the top bumpers 2425 are both made of rubber material or the like, which allows shock absorption and buffering while limiting shaking. The lower surface of the saddle 281 is further provided with a hook lock 2814 arranged just rearwardly of the support surfaces 2813. The fixing crosspin 2426 mates into the hook lock 2814. The fixing crosspin 2426 is preferably cylindrical and extends horizontally in the transverse direction, exposed on the rear end of the upper surface of the mounting bracket body 2423 to cooperatively define a gap with the mounting bracket body 2423 of the rear saddle support bracket 242. When the saddle 281 is securely fixed on the ATV 100, the hook lock 2814 passes through the gap so the saddle 281 is held down by the fixing crosspin 2426. The mounting bracket body 2423 of the rear saddle support bracket 242 is an integrated structure, which reduces the number of components required for manufacturing and lowers manufacturing costs. The rear saddle support bracket 242 can not only provide support for and a means for fixing the saddle 281 so as to facilitate installation of the saddle 281, but can also limit swinging or shaking of one or more components of the electrical system 17.

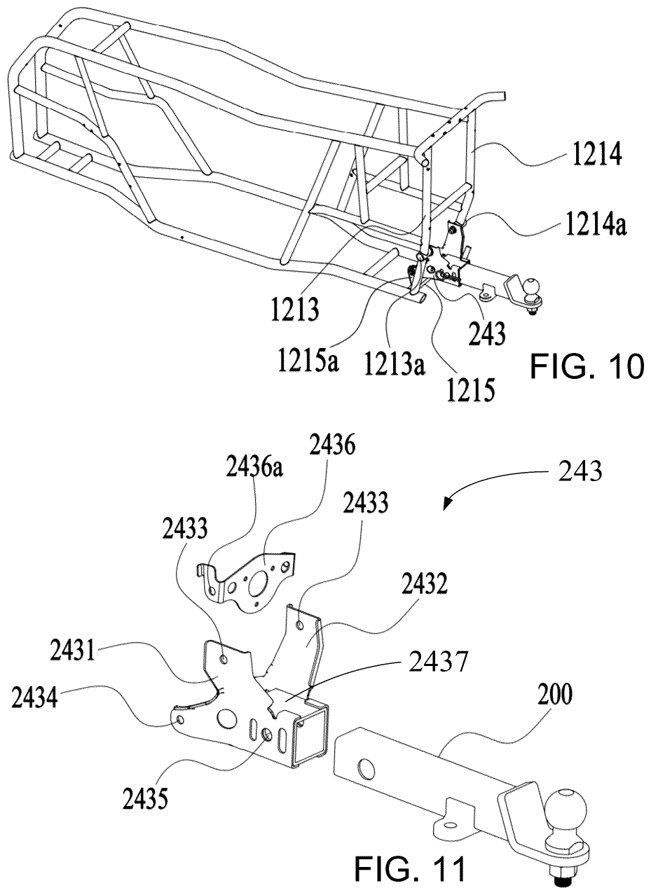

As shown in FIGS. 10 and 11, the collection of mounting brackets 24 further includes a towing bracket 243. The towing bracket 243 is positioned at the rear of the ATV 100 and between the rear left upright 1213 and the rear right upright 1214. The towing bracket 243 is used to provide a receiver tube 2437 for a ball mount towing device 200 so as to achieve a towing function of the ATV 100. The towing bracket 243 includes a left clamp plate 2431 and a right clamp plate 2432. The left clamp plate 2431 and the right clamp plate 2432 are substantially symmetrical with respect to the longitudinal mid-plane 303. The left clamp plate 2431 is connected to the rear left upright 1213 and to the rear base crossbeam 1215, and the right clamp plate 2432 is connected to the rear right upright 1214 and to the rear base crossbeam 1215. Both the left clamp plate 2431 and the right clamp plate 2432 define a top mounting hole 2433, a front mounting hole 2434 and a hitch pin hole 2435, all three sets of holes 2433, 2434, 2435 being substantially symmetrical with respect to the longitudinal mid-plane 303. The left clamp plate 2431 is connected such as by a bolt (not shown) through its top mounting hole 2433 to a clamping surface 1213a of the rear left upright 1213. The right clamp plate 2432 is connected such as by a bolt (not shown) through its top mounting hole 2433 to a clamping surface 1214a of the rear right upright 1214. The left clamp plate 2431 and the right clamp plate 2432 are each connected such as by a bolt (not shown) through its front mounting hole 2434 to a rack 1215a of the rear base crossbeam 1215. The rack 1215a is integrally formed with the rear base crossbeam 1215, and may be fixed to the rear base crossbeam 1215 by means of welding or other methods. In some embodiments, the bolts for fixing the clamp plates 2431, 2432 may extend through shaft sleeves (not shown) made of rubber material or the like, which can effectively reduce wear between the towing bracket 243 and the frame 12, thereby improving the durability of the towing bracket 243. The receiver tube 2437 is welded or otherwise fixed to the left and right clamp plates 2431, 2432, with its rear opening exposed for receiving the ball mount towing device 200. The towing bracket 243 is thus detachable allowing it to be added/removed according to the needs of users and different usage scenarios, which improves assembly convenience and reduce unnecessary assembly costs. Using multiple mounting holes 2433, 2424 optimizes the connection between the towing bracket 243 and the frame 12, thereby making the connection between the frame 12 and the towing bracket 243 more reliable and stable, and effectively improving the durability of the towing bracket 243.

As shown in FIG. 11, the towing bracket 243 further includes a power socket seat 2436. The power socket seat 2436 is mounted between the left clamp plate 2431 and the right clamp plate 2432. A power socket (not shown) which provides an output electrical power interface for a trailer (not shown) is mounted on the power socket seat 2436. Both ends of the power socket seat 2436 define a power socket seat mounting hole 2436a. The power socket seat mounting hole 2436a substantially coincides with the top mounting hole 2433, making it easy to fix the power socket seat 2436 on the clamping surfaces 1213a, 1214a of the rear uprights 1213, 1214. The power socket seat 2436 allows shortening of the length of the power cord (not shown) and facilitates connection of the trailer power plug (not shown). In addition, it is easy to install and disassemble the power socket seat 2436 so use of the power socket seat 2436 and associated power socket can be carried out according to actual needs, thereby improving the practicality and diversity of the ATV 100.

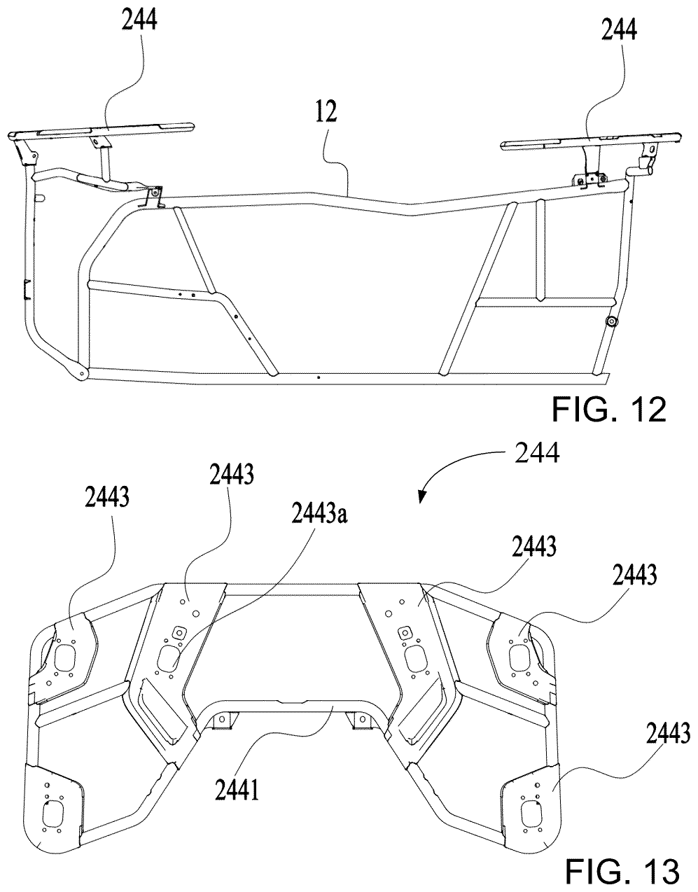

The collection of mounting brackets 24 further includes front and rear shelves 244 shown with reference to FIGS. 12-15, 60 and 61. The shelves 244 may be mounted on the frame 12, each serving as an extension component of the ATV 100. The shelves 244 are used to provide installation locations for external devices or equipment for the ATV 100, thereby allowing the ATV 100 to carry more external devices or equipment.

As shown in FIG. 13 and FIG. 14, each shelf 244 includes a shelf body perimeter tube 2441, one or more interior reinforcement tubes 2442, and preferably a plurality of attachment plates 2443. The interior reinforcement tubes 2442 are positioned in the plane defined by the shelf body perimeter tube 2441 and are connected to the shelf body perimeter tube 2441 such as by welding to improve the structural strength of shelf 244. The attachment plates 2443 are fixed to at least one of the shelf body perimeter tube 2441 or the interior reinforcement tubes 2442. Each attachment plate 2443 defines at least one mounting opening 2443a such as a hole, slot, or the like for mounting external devices or equipment. The number of attachment plates 2443 can be selected according to the user's needs, which can reduce unnecessary waste and cost, and improve the user experience. If desired, handrails (not shown) may be mounted on the shelf 244. The shelf body perimeter tube 2441 is preferably made by an integrated bending forming process, and the interior reinforcement tubes 2442 are connected to the shelf body perimeter tube 2441 such as by welding. The attachment plates 2443 are fixed to the shelf body perimeter tube 2441 and/or the interior reinforcement tubes 2442 such as by welding. The shelf 244 is simple and easy to produce, thus reducing manufacturing costs.

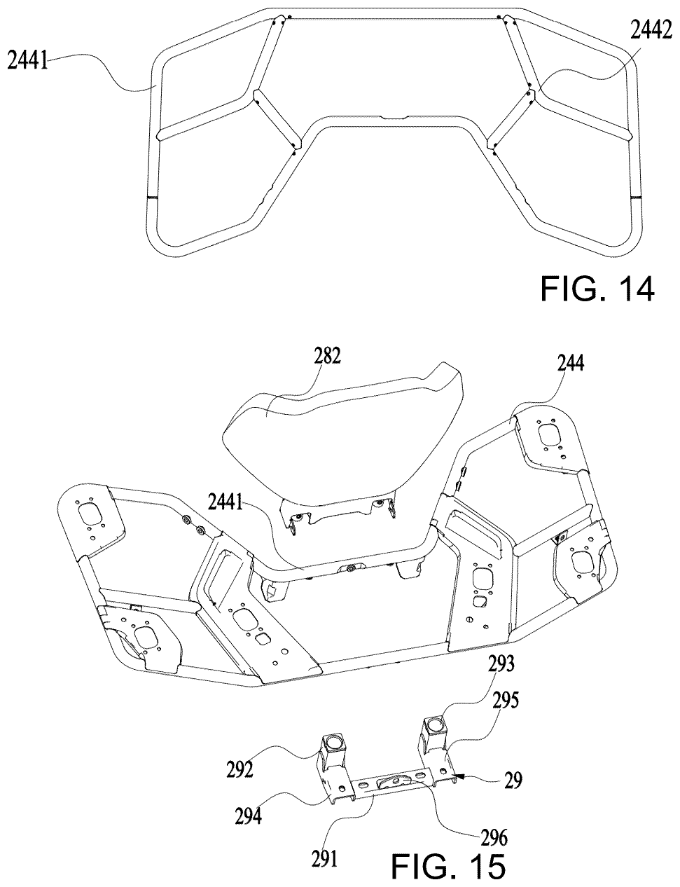

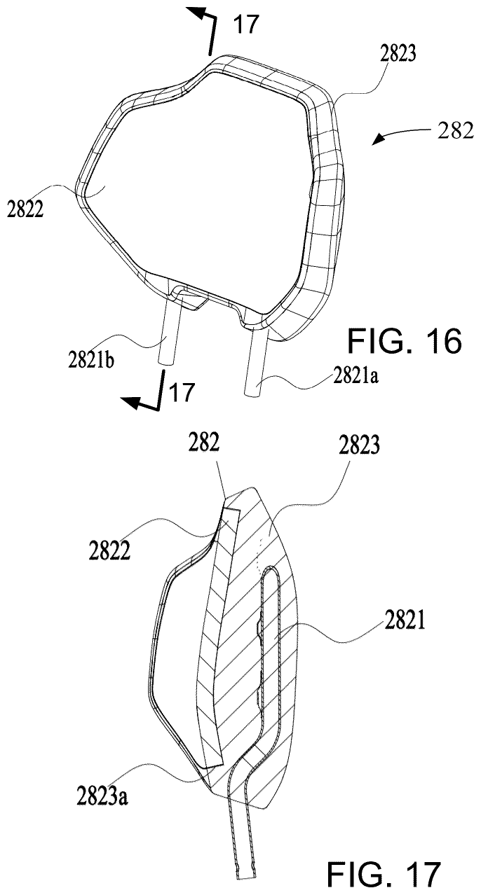

The saddle assembly 28 includes a detachable backrest 282 as shown in FIGS. 15-17, 60 and 61 to provide support for a user's back. The ATV 100 further includes a backrest mounting seat 29 for mounting the backrest 282 on the rear shelf 244. The backrest mounting seat 29 includes a bottom plate 291 extending between a left support flange 294 and a right support flange 295. The left support flange 294 has a left backrest support boss 292, and the right support flange 295 has a right backrest support boss 293. Each backrest support boss 292, 293 defines a cylindrical hole or recess, which receives respective left and right ends 2821a, 2821b of a backrest supporting skeleton 2821. The left and right support flanges 294, 295 keep the respective left and right support bosses 292, 293 stable. The backrest mounting seat 29 is connected such as by bolts (not shown) extending through a connection portion 296 of the bottom plate 291 to a bottom side of the shelf body perimeter tube 2441. The connection portion 296 is preferably an L-shaped member fixed to the bottom plate 291 by welding. The bolted connection allows the backrest mounting seat 29 to be removed from the shelf 244, which is a simple and convenient disassembly method. Users can disassemble and assemble the backrest mounting seat 29 according to their needs. The bolted connection enables the backrest mounting seat 29 to maintain stability in the front-rear (longitudinal), the left-right (transverse), and up-down (vertical) directions on the shelf body perimeter tube 2441. A plurality of weight reduction holes are defined on the bottom plate 291, which can reduce the weight of the bottom plate 291, optimize the force situation of the connection portion 296, and improve the stability of the connection between the connection portion 296 and the shelf body perimeter tube 2441. In some embodiments, a plurality of bushings (not shown) are provided between the connection portion 296 and the shelf body perimeter tube 2441, between the left support flange 294 and the shelf body perimeter tube 2441, and between the right support flange 295 and the shelf body perimeter tube 2441. Such bushings can effectively reduce friction between the backrest mounting seat 29 and the shelf body perimeter tube 2441, thereby reducing wear caused by relative motion between components. The backrest mounting seat 29 makes fixation of the backrest 282 more firm with a higher mounting strength, thereby effectively avoiding the shaking of the backrest 282 during the running of the ATV 100 and improving the stability of the backrest 282. The backrest mounting seat 29 is a simple structure with low production cost, convenient for mounting and disassembly of the backrest 282.

As best shown in FIG. 17, the backrest 282 preferably includes the skeleton 2821 supporting a main backrest cushion 2823, which in turn supports a surface cushion layer 2822. The skeleton 2821 is preferably a metal tubular part used to connect the backrest 282 to the backrest mounting seat 29. The skeleton 2821 and the main backrest cushion 2823 cooperatively form the supporting body of the backrest 282. The surface cushion layer 2822, which makes contact with the user's back, is formed of a softer material than the main backrest cushion 2823. The thickness of the surface cushion layer 2822 is preferably in the range from 20 mm to 30 mm, while the thickness of the main backrest cushion 2823 is preferably in the range from 30 mm to 50 mm. The main backrest cushion 2823 can effectively reduce the passenger's sense of touch pressure with the skeleton 2821. The surface cushion layer 2822 serves as the contact area between the backrest 282 and the user and can improve the user's comfort and provide a good riding experience even though it is thinner than the main backrest cushion 2823. The main backrest cushion 2823 is molded to define a connection recess 2823a, and the surface cushion layer 2822 is at least partially arranged within the connection recess 2823a. The connection recess 2823a facilitates assembly of the surface cushion layer 2822 to the main cushion 2823. In some embodiments, the surface cushion layer 2822 can be connected and fixed to the main backrest cushion 2823 by bonding, which reduces the difficulty of the manufacturing process and simplifies the processing.

The collection of mounting brackets 24 further includes a cradle 247 for fixing the prime mover assembly 11 and/or engine 111 as shown in FIGS. 18 and 19. The cradle 247 is arranged between the left base beam 1216 and the right base beam 1217. The cradle 247 includes a front fixing crossplate 2470, a rear fixing crossplate 2471, and an engine mount member 2472. The fixing crossplates 2470, 2471 are fixed to the frame body 121 between the left base beam 1216 and the right base beam 1217 and are used to transfer the gravity or pressure of the engine 111 to the frame 12. The engine mount member 2472 connects the front side of the engine 111 to the front fixing crossplate 2470.

The engine mount member 2472 includes a left engine mount plate 2472a, a right engine mount plate 2472b, a forward engine support beam 2472c and a rearward engine support beam 2472d. The forward and rearward engine support beams 2472c, 2472d are preferably cylindrical rods connected between the left engine mount plate 2472a and the right engine mount plate 2472b such as by welding so as to extend horizontally and laterally, parallel to each other. The engine support beams 2472c, 2472d improve the structural stability, transferring forces between the left and right engine mount plates 2472a, 2472b, thereby enabling the cradle 247 to have higher support strength. A plurality of engine mount holes 2472e for mounting the engine 111 are defined on the engine mount plates 2472a, 2472b.

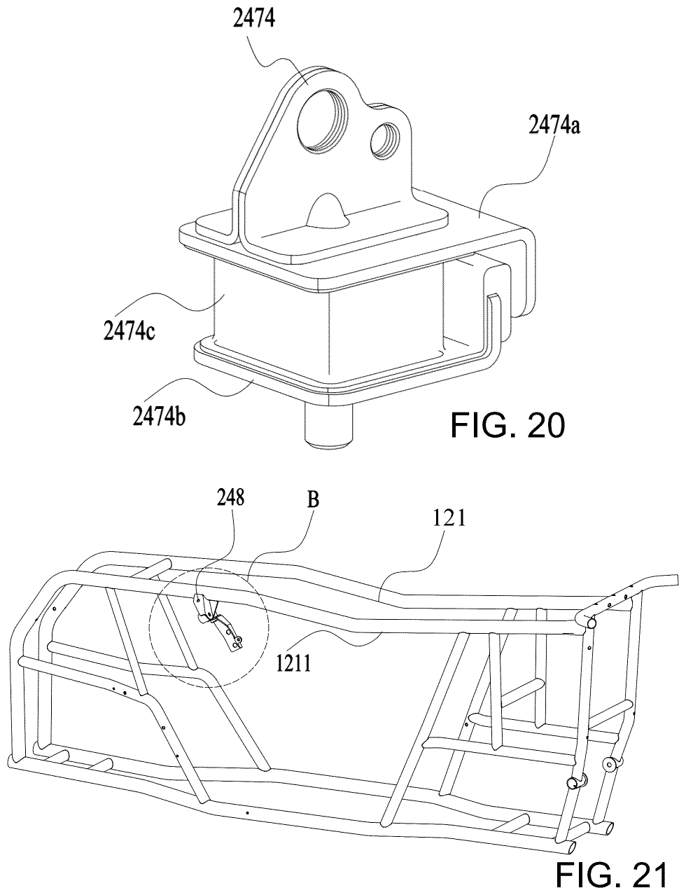

A first, front buffer 2474 is used to connect the engine mount member 2472 to the front fixing crossplate 2470. Second and third rear buffers 2475, 2476 are used at laterally spaced intervals to connect the rear side of the engine 111 to the rear fixing crossplate 2471. Using the front buffer 2474 as an example, the construction of these buffers 2474, 2475, 2476 is better shown in FIG. 20. The front buffer 2474 includes an upper plate 2474a, a lower plate 2474b, and a damping block 2474c. The upper plate 2474a is connected to the engine mount member 2472 such as by a bolted connection. The damping block 2474c is positioned between the upper plate 2474a and the lower plate 2474b. The upper surface of the damping block 2474c is bonded to the upper plate 2474a, and the lower surface of the damping block 2474c is bonded to the lower plate 2474b. The lower plate 2474b is connected to the front fixing crossplate 2470 such as by a bolted connection. The damping block 2474c is made of rubber or a similar resilient material, which can better absorb buffering force and provide shock absorption for the engine 111. The buffers 2474, 2475, 2476 absorb at least part of the vibration and noise generated by the engine 111 when operating, improving the stability of the connection between the engine 111 and the cradle 247.

A front buffer mount angle α is defined between a mount plane of the front fixing crossplate 2470 and horizontal, and a rear buffer mount angle β is defined between a mount plane of the rear fixing crossplate 2471 and horizontal. The front buffer mount angle α is preferably in the range from 15 degrees to 45 degrees, and the rear buffer mount angle β is preferably in the range from 15 degrees to 45 degrees. These preferred values for mount angles α, β optimize the loading of the buffers 2474, 2475, 2476, thereby resulting in higher stability and reliability of the buffers 2474, 2475, 2476. A cradle angle θ defined between the mount plane of the front buffer 2474 and the mount plane of the rear buffers 2475, 2476 is preferably in the range from 60 degrees to 90 degrees. Within this range, the smaller the cradle angle θ is, the more effective it is to optimize the vertical force situation of the front fixing crossplate 2470 and the rear fixing crossplate 2471, so that the fixing crossplates 2470, 2471 can distribute the gravitational pressure from the prime mover assembly 11 in other directions, thereby minimizing the likelihood of the cradle 247 breaking due to excessive concentration of force. The larger the cradle angle θ is, the more effective it is to optimize the horizontal force situation of the front fixing crossplate 2470 and the rear fixing crossplate 2471, so that the fixing crossplates 2470, 2471 can distribute the acceleration and deceleration pressure from the prime mover assembly 11 in other directions. When the cradle angle θ is 60 degrees, the front fixing crossplate 2470 and the rear fixing crossplate 2471 have the best load-bearing effect. The cradle angle θ has a significant impact on the force situation of the fixing crossplates 2470, 2471. If the cradle angle θ is too small or too large, then one or both fixing crossplates 2470, 2471 are subjected to excessive vertical or horizontal force, which can seriously affect the service life of the fixing crossplates 2470, 2471. It should be noted that the angle range above has been found optimal in many situations. In practical applications, corresponding adjustments may also be made according to the actual situation. The three-point connection of the preferred cradle 247 not only provides better fixation effect for prime mover assembly 11 including the engine 111 with improved shock absorption and dampened vibration transmitted to the rider, but also reduces the manufacturing cost of the cradle 247. In addition, the preferred cradle 247 better absorbs forces and oscillation amplitude of prime mover assembly 11 during rapid acceleration and deceleration, thereby avoiding interference between the prime mover assembly 11 and other components.

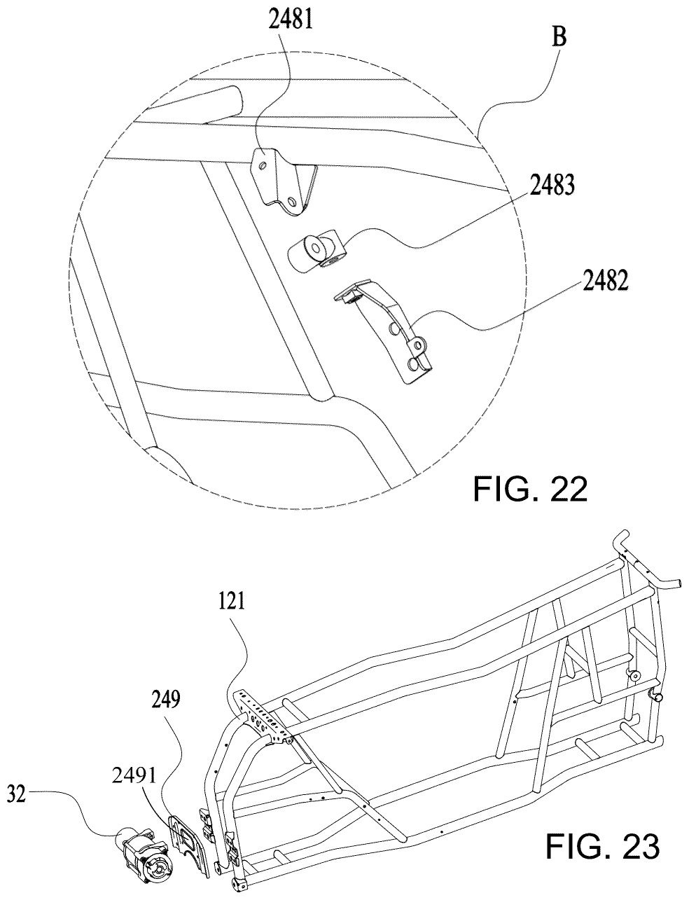

The collection of mounting brackets 24 further includes a cylinder head support 248 shown in FIGS. 21 and 22. The cylinder head support 248 and limits the oscillation of the cylinder head 1112 (called out in FIG. 3). As shown in FIG. 22, the cylinder head support 248 includes a hanger bracket 2481, a head mount plate 2482, and an elastic adapter 2483. The hanger bracket 2481 is fixedly mounted on the top left main beam 1211 such as by welding. The head mount plate 2482 is connected to the cylinder head 1112 of the engine 111 such as by bolts (not shown). The elastic adapter 2483 connects the head mount plate 2482 to the hanger bracket 2481. The elastic adapter 2483 may be made of rubber or similar material. The amplitude of left-right oscillation of the cylinder head 1112 is dampened by utilizing the clastic deformation of the rubber material, which reduces the transmission of engine vibration, and also reduces the friction and wear between the hanger bracket 2481, the head mount plate 2482, and the elastic adapter 2483, thereby improving the service life of the cylinder head support 248. The cylinder head support 248 can prevent the engine 111 from swinging too much in the left-right direction, which effectively reduces the lateral swinging distance of the engine 111, thereby reducing the risk of collision between the cylinder head 1112 and the frame 12 or other vehicle components, while simultaneously decreasing loads on the front and rear fixing crossplates 2470, 2471 of the cradle 247.

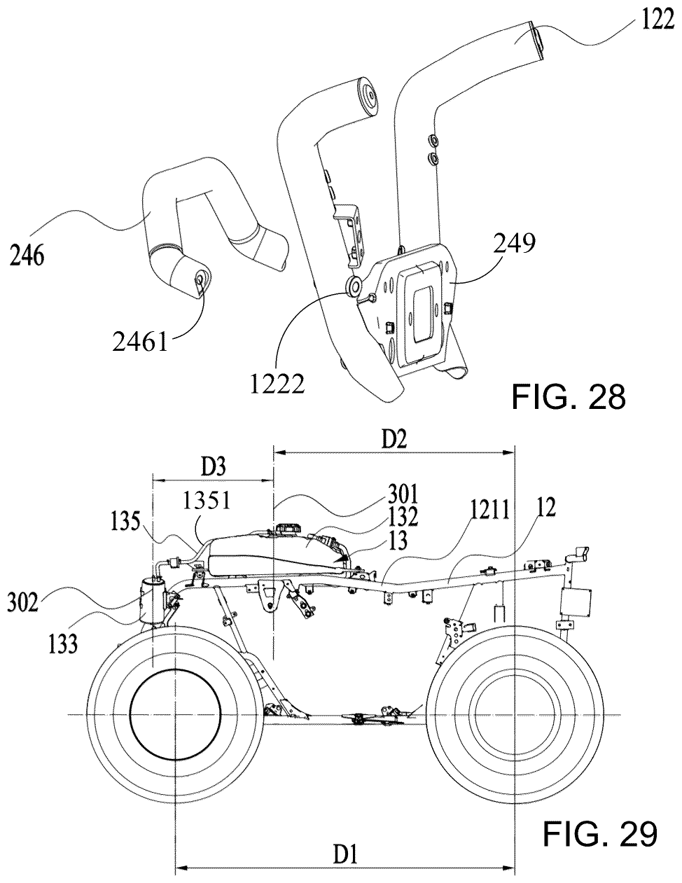

The collection of mounting brackets 24 further includes a winch mount plate 249 shown in FIGS. 4, 23 and 28. The winch mount plate 249 is preferably mounted on the front end of the main body 121 of the frame 12 as shown in FIG. 23. Alternatively, the winch mount plate 249 is mounted on the front end of the front brace 122 of the frame 12 as shown in FIGS. 4 and 28. A winch 32 is mounted on the winch mount plate 249. The winch 32 is a horizontal drum carrying a winding flexible component (such as a steel wire rope or chain). The horizontal drum is rotated by human or mechanical power. The winch 32 can be used to perform tasks such as clearing obstacles, dragging objects, or extracting the ATV 100 out of harsh environments such as snow, swamps, deserts, beaches, and muddy mountain roads. The width of the winch mount plate 249 is greater than the width of the front of the main body 121, so as to mount the winch 32 more casily. The winch mount plate 249 is made of metal material with strong rigidity. One or a plurality of weight reduction holes 2491 are defined on the winch mount plate 249 to reduce the weight of the winch mount plate 249. The winch mount plate 249 is preferably connected to the frame body 121 by means of bolts (not shown). The winch mount plate 249 can thus be selectively mounted or detached according to the user's needs, which reduces production costs, is easy to install and disassemble, and saves time and effort in maintenance.

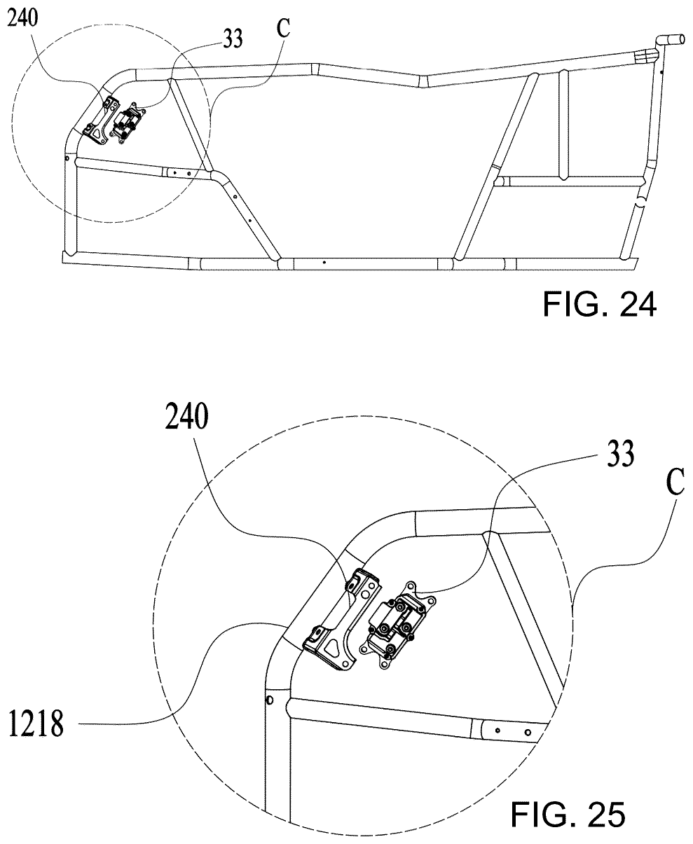

The collection of mounting brackets 24 further includes a winch relay mount bracket 240 shown in FIGS. 24 and 25. A winch relay 33 is mounted on winch relay mount bracket 240, which is used to conduct/disconnect the current output from the electrical system 17 to the winch 32. The winch relay mount bracket 240 is positioned near the winch 32 such as on one or both of the two front uprights 1218 at the front end of the ATV 100 above the winch 32. The winch relay mount bracket 240 is preferably behind and beneath an angled portion of the front upright 1218, so the front upright 1218 and the winch relay mount bracket 240 help to protect the winch relay 33, helping to minimize dust and water incursion and extending the service life of the winch relay 33. The winch relay mount bracket 240 may be mounted by means of welding or by bolts (not shown). The winch relay 33 is then detachably connected to the winch relay mount bracket 240 by preferably means of bolts (not shown). For instance, a thread sleeve (not shown) for guiding bolts may be arranged between one or both front uprights 1218 and the winch relay mount bracket 240, which can facilitate the mounting and positioning of the bolts. During movement of the ATV 100, the thread sleeve can absorb the friction force between the winch relay mount bracket 240 and the front uprights 1218, thereby reducing wear.

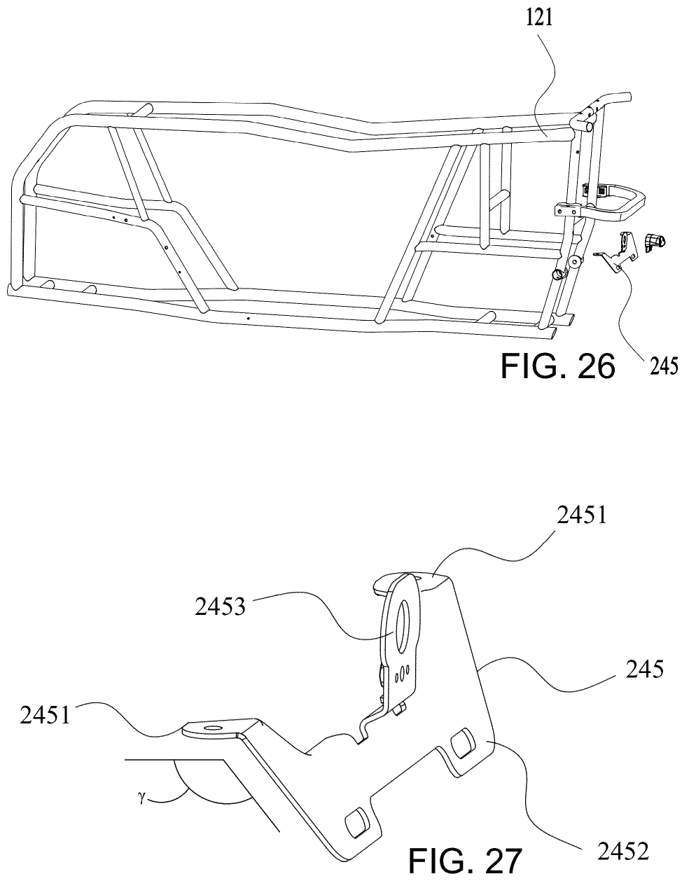

The collection of mounting brackets 24 further includes a license plate holder 245 shown in FIGS. 26 and 27. The license plate holder 245 is used mounting a license plate (not shown) of the ATV 100. The license plate holder 245 includes two fixing flanges 2451, a plate mounting portion 2452 and a lamp mounting portion 2453. The two fixing flanges 2451 each have a bolt hole defined therein so the license plate holder 245 can be connected to the frame body 121 by bolts (not shown), which is conducive to maintenance or replacement of the license plate holder 245. The lamp mounting portion 2453 projects over the plate mounting portion 2452, so a license plate lamp (not shown) can be mounted to project light downwardly onto a license plate mounted on the plate mounting portion 2452. A license plate angle γ defined between the plate mounting portion 2452 and the fixing flanges 2451 is greater than 90 degrees, such that the license plate surface will be angled to face upwardly and rearwardly. A license plate angle γ of greater than 90 degrees can prevent the frame 12 from obstructing the license plate and make it easier for observers to see the license plate more intuitively, and facilitating mounting of the license plate. The two fixing flanges 2451, the plate mounting portion 2452, and the lamp mounting portion 2453 are integrated, which can reduce production cost.

The collection of mounting brackets 24 further includes a front bumper 246 shown in FIG. 28. The front bumper 246 serves as a safety device to absorb external impact forces and protect the front of the vehicle 100. The front bumper 246 is preferably detachably mounted on the front side of the front brace 122. For instance, threaded holes 2461 are defined on the rear ends of the front bumper 246, and connecting bolts (not shown) can be inserted through bushings 1222 of the front brace 122 and threadingly tightened into the threaded holes 2461 to secure the front bumper 246 to the front brace 122. When passing through special road sections (for example, in some steep road sections), the front bumper 246 may collide with the road surface, which is not conducive to the user driving experience. Having the front bumper 246 be detachable allows users to disassemble the front bumper 246 according to different usage scenarios, allowing the ATV 100 to obtain a larger approach angle on special road sections, thereby enabling the ATV 100 to drive on steep slopes and overcome larger obstacles. The preferred ATV 100 thus improves the drawbacks of existing designs by mounting a detachable front bumper 246, which is conducive to personalized settings for users.

The fuel system 13 is positioned in the front of the ATV 100 and is further explained with reference to FIGS. 29-33. The fuel system 13 includes a fuel pump 131, a fuel tank 132, a carbon canister 133, a fuel filter 134, and several pipelines 135 all mounted on the frame 12. The pipelines 135 include a fuel vapor pipeline 1351, a leak fuel pipeline 1352, and a primary fuel pipeline 1353. The fuel tank 132 is preferably mounted on the top left main beam 1211 and the top right main beam 1212. The carbon canister 133 is mounted on the frame 12, preferably in front of the fuel tank 132. The carbon canister 133 may be arranged on the left side or the right side of the ATV 100. The fuel tank 132 is used for storing fuel. A fuel vapor port 1323 is defined on the fuel tank 132, and the carbon canister 133 is connected to the fuel vapor port 1323 through the fuel vapor pipeline 1351. Activated carbon in the carbon canister 133 absorbs excess fuel vapor from the fuel tank 132.

The preferred layout of the carbon canister 133 and the fuel tank 132 on the ATV 100 is best understood with reference to FIG. 29. A wheelbase distance D1 is defined as the horizontal longitudinal distance between a front wheel axis centerline and a rear wheel axis. A fuel tank transverse mid-plane 301 is defined as a vertical transverse plane with half of the volume of the fuel tank 132 in front of the fuel tank transverse mid-plane 301 and half of the volume of the fuel tank 132 behind the fuel tank transverse mid-plane 301. A fuel tank longitudinal position distance D2 is defined as the horizontal longitudinal distance between the fuel tank transverse mid-plane 301 and the rear wheel axis. A fuel tank longitudinal ratio D2/D1 of the fuel tank longitudinal position distance D2 to the wheelbase distance D1 is preferably in the range from 0.65 to 0.75, more preferably in the range from 0.67 to 0.72. These value ranges for the fuel tank longitudinal ratio D2/D1 keep the fuel tank 132 far away from the primarily heat source in the front-rear direction of the ATV 100, increasing the distance of heat transfer and thereby reducing the effect of heat on the fuel tank 132 and reducing volatilization of fuel, while still saving internal space of the ATV 100 and improving the stability of the ATV 100 due to the varying weight of the fuel tank 132.

A carbon canister transverse mid-plane 302 is defined as a vertical transverse plane with half of the volume of the carbon canister 133 in front of the carbon canister transverse mid-plane 302 and half of the volume of the carbon canister 133 behind the carbon canister transverse mid-plane 302. A carbon canister lead distance D3 is defined as the horizontal longitudinal distance between the carbon canister transverse mid-plane 302 and the fuel tank transverse mid-plane 301. A carbon canister lead ratio D3/D1 of the carbon canister lead distance D3 to the wheelbase distance D1 is preferably in the range from 0.3 to 0.4, and more preferably in the range from 0.33 to 0.36. These value ranges for the carbon canister lead ratio D3/D1 allow the fuel vapor pipeline 1351 to have high universality and use on vehicle models with different body lengths and different wheelbase distances.

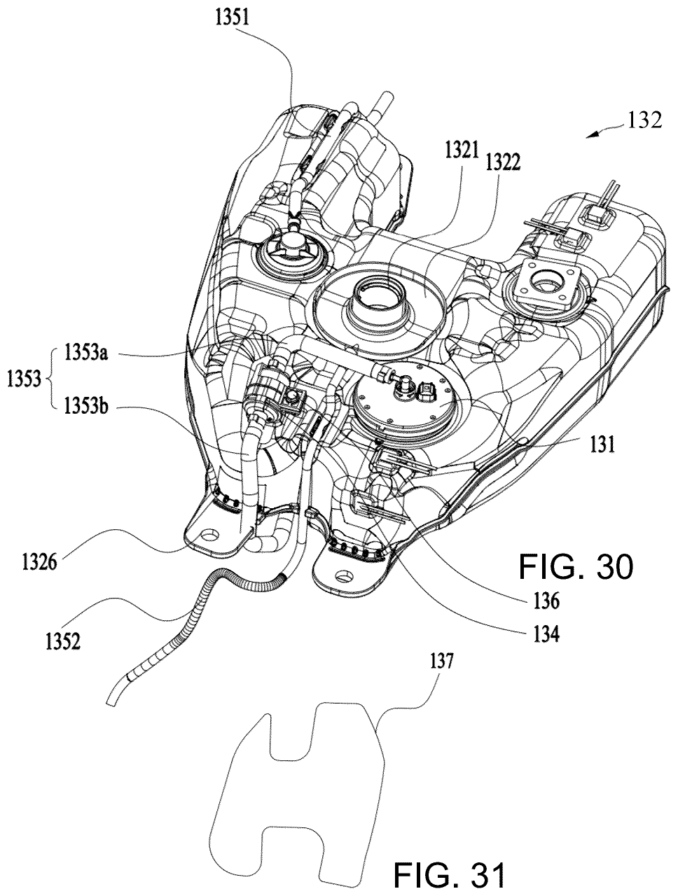

As shown in FIG. 30, the fuel pump 131 is positioned above the fuel tank 132. The fuel pump 131 is connected to the engine 111 by the primary fuel pipeline 1353, delivering fuel to the engine 111. The leak fuel pipeline 1352 is used to guide any fuel spilled during refueling to the ground.

The fuel filter 134 is positioned in the primary fuel pipeline 1353 between the fuel pump 131 and the engine 111, such as by splitting the primary fuel pipeline 1353 into a first fuel pipeline section 1353a and a second fuel pipeline section 1353b. The fuel filter 134 is used to prevent particles, water, and impurities from entering the engine 111, thereby ensuring that the precision components in the engine 111 and in the fuel system 13 are not worn or damaged. The fuel filter 134 is preferably mounted on the upper surface of the fuel tank 132 by means of a filter bracket 136. The filter bracket 136 defines an opening sized to receive the outer diameter size of the fuel filter 134. The filter bracket 136 is connected to the fuel tank 132 by one or more bolts, and a convex limit structure is also arranged on the filter bracket 136 to hold the fuel filter 134 in place. Alternatively, the filter bracket 136 may be connected to the fuel tank 132 by means of hot melting, forming an integrated mount structure between the filter bracket 136 and the fuel tank 132. There is no need to arrange an installation position for the filter bracket 136 on the frame body 121, which can greatly save assembly space. The fuel tank 132 and fuel filter 134 can be mounted or removed in an integrated manner, thereby making it easy for users to repair or replace.

As shown in FIG. 30, the fuel tank 132 is further equipped with a refueling channel 1321 and a fuel overflow pan 1322. The fuel overflow pan 1322 is arranged above the refueling channel 1321, and the fuel overflow pan 1322 is fluidly connected to the leak fuel pipeline 1352. The leak fuel pipeline 1352 is used to export any liquid accumulated on the fuel overflow pan 1322. Any fuel spilled during the refueling of the ATV 100 can be received by the fuel overflow pan 1322 and directed to the ground through the leak fuel pipeline 1352. The fuel overflow pan 1322 and leak fuel pipeline 1352 can also export any rainwater and other sewage that collects near the refueling channel 1321 to protect the fuel tank 132 from pollution.

FIG. 31 shows a fuel tank insulation pad 137, which is preferably mounted on the bottom surface of fuel tank 132. The shape and contour of the fuel tank insulation pad 137 is substantially the same as the shape and outer contour of the bottom surface of the fuel tank 132, thereby making it easy for the fuel tank insulation pad 137 to fully cover the bottom surface of the fuel tank 132. In order to facilitate the fixation between the fuel tank insulation pad 137 and the fuel tank 132, a layer of adhesive (not shown) is spread on the fuel tank insulation pad 137 and bonded to the bottom surface of the fuel tank 132. The coverage area of the fuel tank insulation pad 137 is greater than or equal to the bottom surface area of the fuel tank 132, thereby achieving better adhesion of the fuel tank insulation pad 137 to the fuel tank 132. The fuel tank insulation pad 137 helps isolate the heat source of the engine 111, thereby reducing the amount of fuel volatilization. At the same time, the fuel tank insulation pad 137 can also protect the local groove structure of the bottom surface of the fuel tank 132 from being compressed by other components inside the ATV 100.

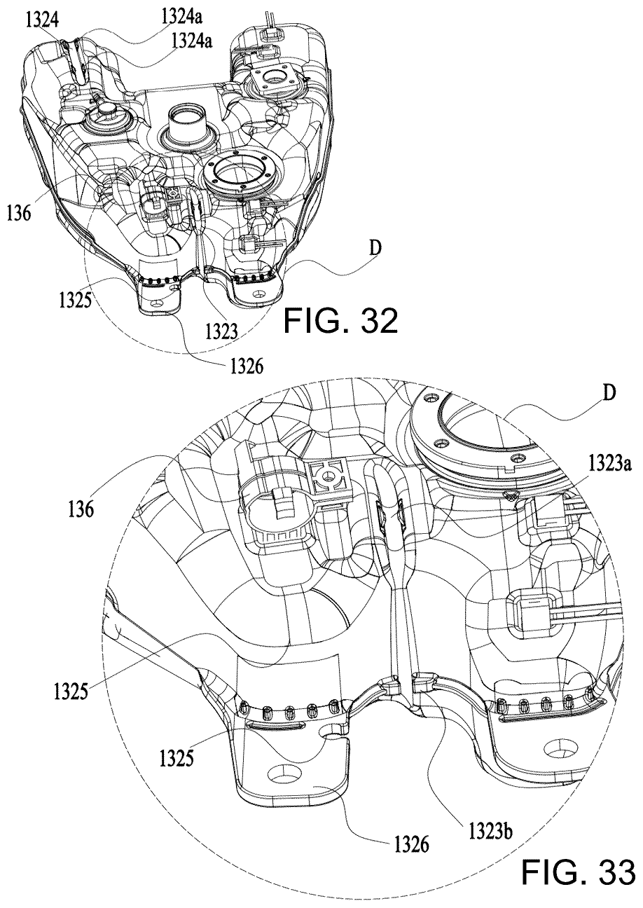

FIGS. 32 and 33 show the fuel tank 132 by itself, without showing the fuel pump 131, the fuel filter 134, or any of the pipelines 135. A leak fuel pipeline slot 1323, a fuel vapor pipeline slot 1324, and a primary fuel pipeline slot 1325 are defined on the exterior profile of the fuel tank 132. The leak fuel pipeline slot 1323 is used to place and fix the leak fuel pipeline 1352. The depth of the leak fuel pipeline slot 1323 is greater than or equal to the radius of the leak fuel pipeline 1352. At least one limit portion 1323a defined between protrusions is used to retain the leak fuel pipeline 1352 in the leak fuel pipeline slot 1323. The notch between the protrusions of the limit portion 1323a is narrower than the diameter of the leak fuel pipeline 1352, and the leak fuel pipeline 1352 can be pressed into the limit portion 1323a to hold the leak fuel pipeline 1352 in place on the fuel tank 132. The leak fuel pipeline slot 1323 thus limits the direction and relative shaking of the leak fuel pipeline 1352 on the fuel tank 132.

The leak fuel pipeline slot 1323 is preferably arranged along a parting surface of the fuel tank 132. The parting surface refers to the contact surface of the mold halves that directly form the fuel tank 132. In the preferred embodiment, the parting surface of the fuel tank 132 extends longitudinally in the middle of the fuel tank 132. Locating the leak fuel pipeline slot 1323 on the parting surface of the fuel tank 132 can facilitate machining associated with the leak fuel pipeline slot 1323 into the mold halves and make it easier to separate/eject the fuel tank 132 from its mold. A circular arc groove 1323b is defined on the seam of the fuel tank 132, and the leak fuel pipeline 1352 passes downwardly through the circular arc groove 1323b. The circular arc groove 1323b keeps the seam of the fuel tank 132 from causing wear on the leak fuel pipeline 1352, thereby protecting the leak fuel pipeline 1352.

The fuel vapor pipeline slot 1324 is arranged on the fuel tank 132 and is positioned on the same side of the fuel tank 132 as the carbon canister 133. The fuel vapor pipeline slot 1324 is used to place and fix the fuel vapor pipeline 1351. The depth of the fuel vapor pipeline slot 1324 is greater than or equal to the radius of the fuel vapor pipeline 1351. At least one second limit portion 1324a is also provided in the fuel vapor pipeline slot 1324, which operates similarly to the limit portion 1323a of the leak fuel pipeline slot 1323.

The primary fuel pipeline slot 1325 is similarly used to limit the direction or relative shaking of the primary fuel pipeline 1353. At least four fuel tank fixing tabs 1326 are also provided on the fuel tank 132, which are preferably positioned on the front end and rear end of the fuel tank 132 and are used to fix the fuel tank 132 to the frame 12. In the preferred embodiment, the primary fuel pipeline slot 1325 is at least partially defined on one of the fuel tank fixing tabs 1326. The leak fuel pipeline slot 1323, the fuel vapor pipeline slot 1324, and the primary fuel pipeline slot 1325 allow quick and secure assembly thereby reducing manufacturing costs, and have an additional benefit of slightly reducing the length of the pipelines 135.

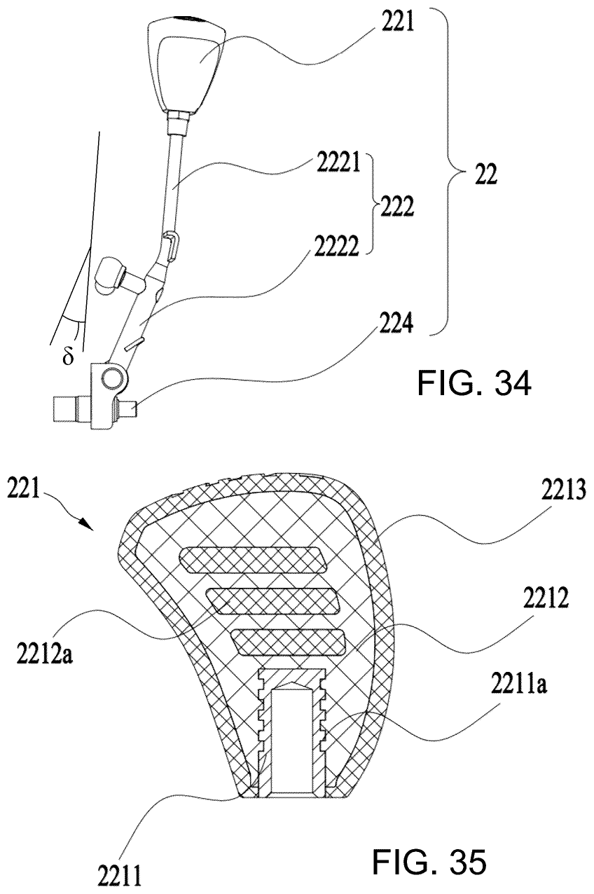

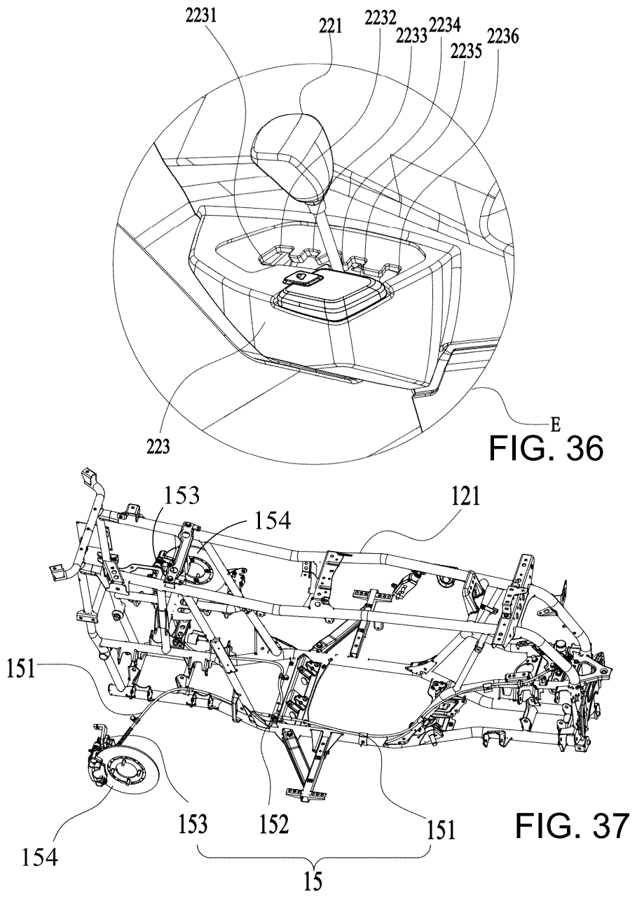

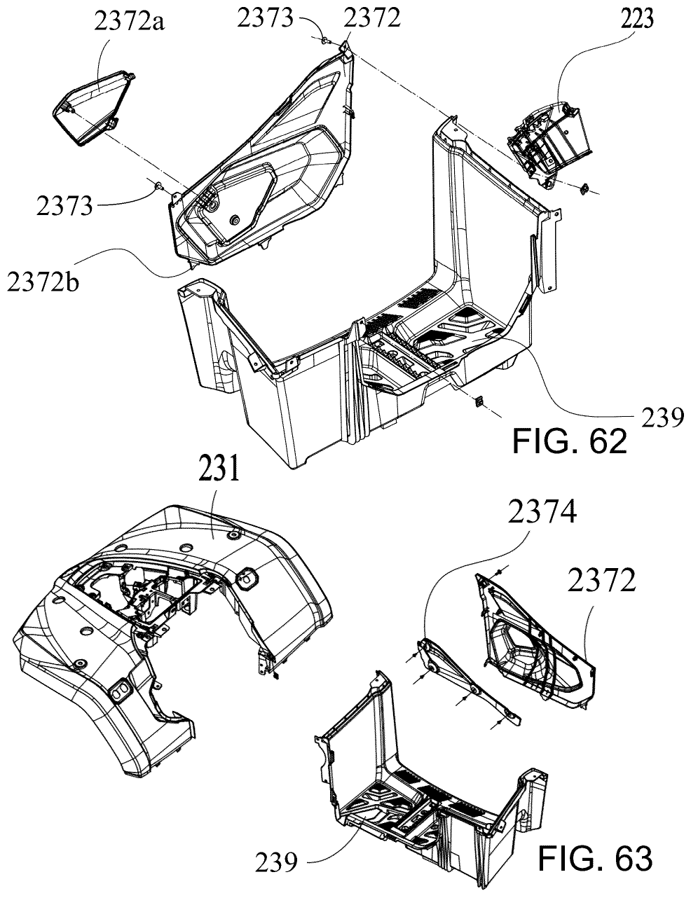

The gearshift assembly 22 is connected to the transmission 14, and the user can control the transmission 14 by moving a shift lever 222 of the gearshift assembly 22. The gearshift assembly 22 is preferably mounted on the left side of the ATV 100 (see FIG. 1), which can allow the user to control the transmission 14 with their left hand. As shown in FIG. 34, the gearshift assembly 22 includes a shift handle 221 on a distal end of the shift lever 222, which the user pushes or pulls to pivot the shift lever 222 and move a shift rotation shaft 224. The shift lever 222 passes through a shift track cover 223 shown in FIGS. 36 and 62, and the shift rotation shaft 224 is beneath the shift track cover 223.

A cross-section through the shift handle 221 is shown in FIG. 35. The shift handle 221 includes a shift handle base 2211, an intermediate layer 2212, and a covering layer 2213. The bottom end of the shift handle base 2211 is connected to the shift lever 222 by means of threads, and the shift lever 222 is at least partially positioned in the shift handle base 2211. A plurality of anti-slip grooves 2211a for meshing and connecting with the intermediate layer 2212 are defined on the upper outer surface of the shift handle base 2211. The width of each anti-slip groove 2211a is substantially equal. At least a portion of the shift handle base 2211 is arranged in the intermediate layer 2212. Multiple through holes 2212a are defined in the interior of the intermediate layer 2212, and the covering layer 2213 at least partially penetrates through the through holes 2212a so as to connect to the intermediate layer 2212, thereby fixing the covering layer 2213 on the intermediate layer 2212. The covering layer 2213 comes in contact with the user's hand and improve the user's comfort. The covering layer 2213 defines a closed loop through the through holes 2212a inside the intermediate layer 2212, thereby maximizing the contact area between the covering layer 2213 and the intermediate layer 2212 and thereby ensuring seamless connection and fixation between the two. The material hardness used in the intermediate layer 2212 is greater than that of the cover layer 2213. The intermediate layer 2212 and the cover layer 2213 can be achieved through injection molding technology. The intermediate layer 2212 is seamlessly connected to the anti-slip groove 2211a on the shift handle base 2211 through insert injection molding, thereby fixing the intermediate layer 2212 on the shift handle base 2211. For instance, the shift handle base 2211 may be an embedded metal component. To ensure user comfort during use, the covering layer 2213 is preferably made of EPDM (ethylene propylene diene monomer rubber) polymer, which has a softer texture, lower cost, and better injection molding effect. The shift handle 221 in this embodiment is less prone to injection molding defects during manufacturing, and its internal structure is more stable. The thickness of the portion where the shift handle 221 comes into contact with the user is uniform, and comfort is better.

The shift lever 222 includes an upper shift lever shaft 2221 and a lower shift lever shaft 2222 as shown in FIG. 34. Both the upper shift lever shaft 2221 and the lower shift lever shaft 2222 are substantially cylindrical. The upper shift lever shaft 2221 and the lower shift lever shaft 2222 cooperatively define a certain shift lever bending angle δ at the connection, and the shift lever bending angle δ may be in the range from 0 to 90 degrees or more. The shift lever bending angle δ refers to the angle defined between the axis of the upper shift lever shaft 2221 and the axis of the lower shift lever shaft 2222. In existing terrain vehicles, the position of the gearshift assembly is not reasonable, and the arrangement of the shift handle is generally far away from the vehicle cover. For users with relatively shorter arm lengths, the operation is more laborious and lacks universality. Moreover, the user's vision is often obstructed by the vehicle cover, which makes it inconvenient for the user to control. The shift lever bending angle δ can be adjusted to prevent the shift handle 221 from being obstructed by the vehicle cover 23, thereby making it easier for users to use and easy to mount or remove. The shift lever bending angle δ may be similarly adjusted in order to facilitate the setting of the lower shift lever shaft 2222, make reasonable use of the internal space of the vehicle body, and reducing manufacturing costs. The position of the connection between the upper shift lever shaft 2221 and the lower shift lever shaft 2222 is lower than the plane of the shift track cover 223, so that the gearshift assembly 22 can be closer to the position of the vehicle cover 23. This can facilitate allowing the user to move the shift lever 222 via the shift handle 221, thereby making the operation more convenient and time-saving. Based on scientific human-machine interaction design, a more comfortable human-machine interaction feeling can be obtained, with better universality, making the user's control posture when operating the gearshift assembly 22 more healthy, avoiding the health impact caused by poor posture, and increasing comfort during use.

As shown in FIG. 36, the shift track cover 223 defines a sliding groove 2231, a first gear slot 2232, a second gear slot 2233, a third gear slot 2234, a fourth gear slot 2235, and a fifth gear slot 2236. The sliding groove 2231 is connected to various gear slots 2232-2236. Using the sliding groove 2231, the shift lever 222 can be moved between the various gear slots 2232-2236, thereby achieving the purpose of switching the transmission 14 and the driving status of ATV 100. Each gear slot 2232-2236 corresponds to an ATV driving gear, for example, the first gear slot 2232 corresponds to a parking gear, the second gear slot 2233 corresponds to a reverse gear, the third gear slot 2234 corresponds to a neutral gear, the fourth gear slot 2235 corresponds to a high gear, and the fifth gear slot 2236 corresponds to a low gear. It can be understood that the order of gear slots can be selected according to vehicle designer preferences. Users can control the shift lever 222 to move in the sliding groove 2231 through the shift handle 221 to enter the desired gear slot 2232-2236 according to the driving needs of the ATV 100, changing the driving status of the ATV 100.

The ATV 100 further includes a braking system 15 as shown in FIG. 37, which is associated with the wheels 26 to achieve braking control. The braking system 15 includes a brake fluid pipeline 151, a tee connector 152, and a plurality of brakes 153 each on a rotor 154. The tee connector 152 allows branching of the brake fluid pipeline 151 to each brake 153.

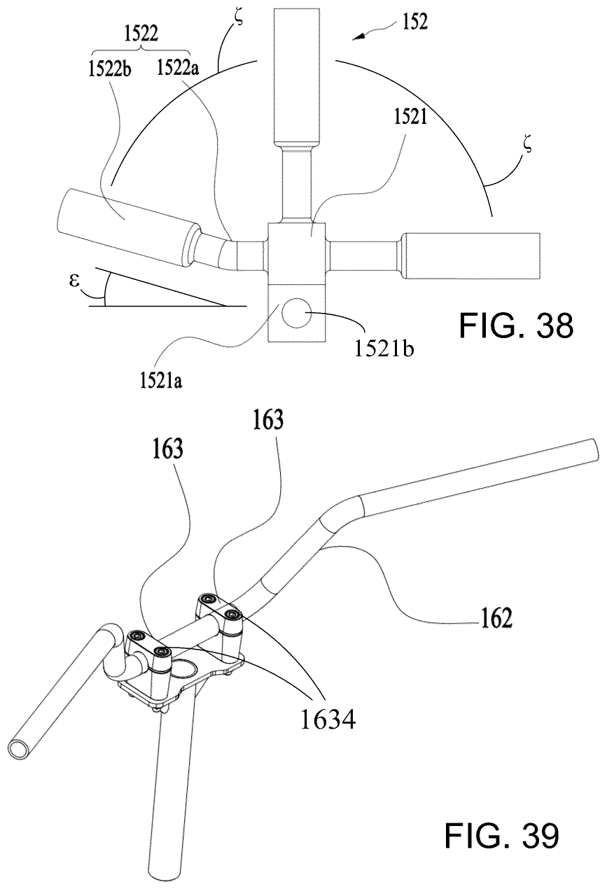

The preferred tee connector 152 is better shown in FIG. 38. The tee connector 152 includes a central junction block 1521 with three outlet pipe stubs 1522. The three outlet pipe stubs 1522 are in internal fluid communication through the junction block 1521.

The junction block 1521 has a fixing tab 1521a with a bolt hole 1521b therethrough. The junction block 1521 may be mounted on the frame body 121 by means of a bolt (not shown) through the fixing tab 1521a. The fixing tab 1521a and three outlet pipe stubs 1522 are respectively arranged in different directions on the junction block 1521 substantially in a cross (+) shape.

Due to the many internal parts in ATV vehicle bodies, brake pipelines need to transmit brake fluid in different directions. In existing technology, brake fluid direction changes are mostly achieved by bending the brake fluid pipeline. However, most existing brake fluid pipelines are formed of a tubing material that will crimp if the radius of curvature of the brake fluid pipeline is made too small. The layout of the internal space of existing vehicle bodies has to accordingly accommodate for large radius turns of brake fluid pipelines, which is not conducive to good layout design. In the preferred tee connector 152, at least one, and more preferably all three of the outlet pipe stubs 1522 include a bending portion 1522a and a straight attachment portion 1522b. The bending portion 1522a can be bent in a tight radius without crimping. The bending angle & of any single bending portion 1522a can be adjusted in the range from 0 degree to 90 degrees, and the angle ζ defined between the straight attachment portions 1522b of any two adjacent outlet pipe stubs 1522 can be adjusted anywhere in the range from 30 degrees to 150 degrees. By allowing bending of the outlet pipe stubs 1522, the brake fluid pipeline 151 can be arranged as desired with less chance of crimping, effectively lessening the likelihood of brake fluid leakage while making the arrangement of the brake pipeline 151 easier, providing more choices for the design of the internal space of the ATV 100 and effectively saving internal space of the vehicle body. The bending structure can also make the flow of brake fluid smoother. Once bent to its desired direction, the direction of the straight attachment portion 1522b of each of the outlet pipe stubs 1522 can be fixed such as by spotwelding the tee connector 152 to the frame 12.

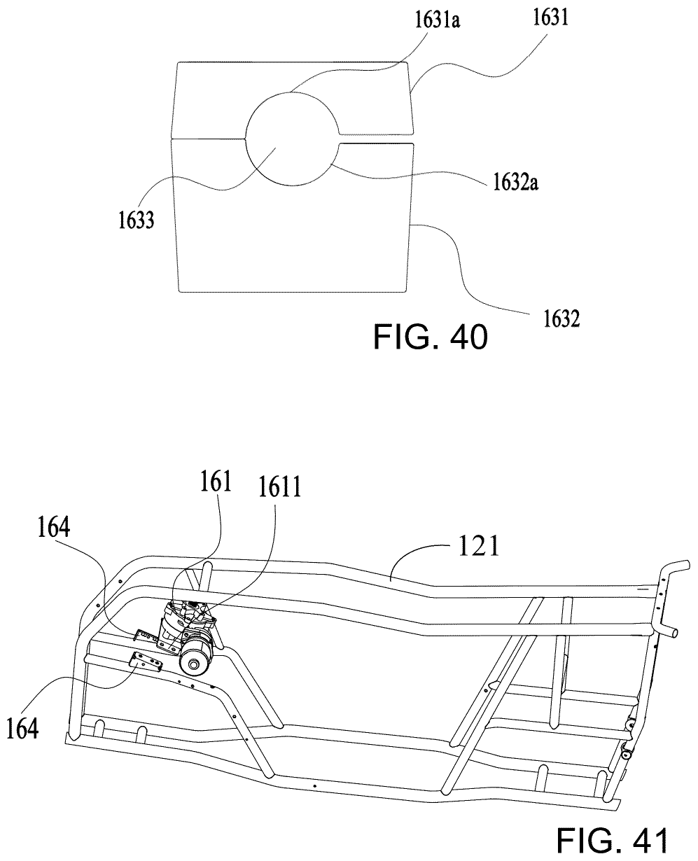

The steering assembly 16 is positioned at the front of the ATV 100. The steering assembly 16 includes an EPS (Electric Power Steering) module 161 shown in FIG. 41, a handlebar 162 shown in FIG. 39, and two handlebar fixing blocks 163 shown in FIGS. 39 and 40. The EPS module 161 is used to provide assistance for steering of the ATV 100. As shown in FIGS. 39 and 40, each handlebar fixing block 163 includes a top pressure block 1631 and a bottom pressure block 1632. The top pressure block 1631 is detachably fixed above the bottom pressure block 1632 by bolts 1634. The top pressure block 1631 is equipped with throughholes countersunk for hiding the bolts 1634, which is more aesthetically pleasing while protecting the bolts 1634. The bottom pressure block 1632 is equipped with a threaded screw hole (not shown) for connection, and the bolts 1634 pass through the top pressure block 1631 into threaded connection with the bottom pressure block 1632, thereby connecting and fixing the top pressure block 1631 to the bottom pressure block 1632. A first groove 1631a is defined on the bottom of the top pressure block 1631, and a second groove 1632a is defined on the bottom pressure block 1632. The first groove 1631a and the second groove 1632a cooperatively define a first mount space 1633 where the handlebar 162 runs through. While the bolts 1634 are loose, the top pressure block 1631 can be at least partially spaced apart by a gap from the bottom pressure block 1632, so that the position of the handlebar 162 can be easily adjusted. When the bolts 1634 are tightened to pull the top pressure block 1631 down onto the bottom pressure block 1632, the mount space 1633 is in an interference fit with the handlebar 162, thereby fixing the handlebar 162. In existing all-terrain vehicles, the handlebar is generally mounted to the frame by means of bolts; in order to ensure consistent tightness of two sides, calibration is required, which is time-consuming and laborious. With the preferred handlebar fixing blocks 163, the handlebar 162 can be quickly and stably fixed to the handlebar fixing blocks 163. Both the top pressure block 1631 and the bottom pressure block 1632 are preferably made of aluminum. The handlebar fixing blocks 163 improve the convenience of assembling the handlebar 162, thereby making fixation of the handlebar 162 more stable and reliable.

As shown in FIG. 41, the EPS module 161 is fixed to the frame body 121 by left and right EPS mounting brackets 164. Each EPS mounting bracket 164 is preferably welded to the frame body 121 below the EPS module 161. The lower half of the EPS module 161 includes a mount fixing portion 1611, which has defined holes to connect the EPS module 161 to the EPS mounting brackets 164 by bolts (not shown). The EPS mounting bracket 164 firmly fixes the EPS module 161 to the frame body 121, reducing shaking of the EPS module 161 during steering, and avoiding bolt breakage.

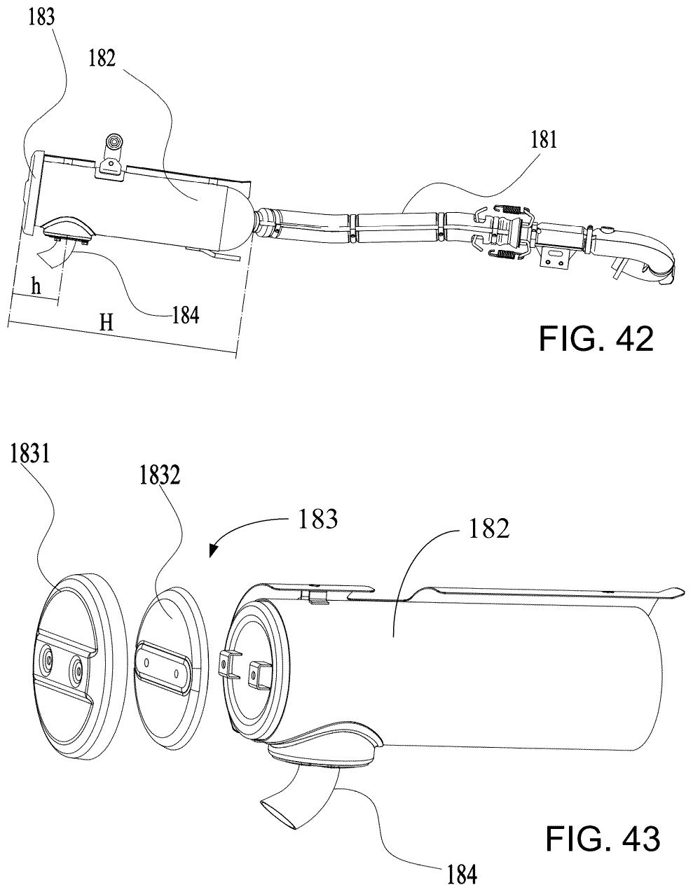

The exhaust system 18 is used to exhaust the fumes output by the engine 111. As shown in FIG. 42, the exhaust system 18 includes an exhaust pipe 181 and a muffler 182. Exhaust fumes enter the muffler 182 through the exhaust pipe 181 and are discharged into the outside air through the muffler 182. The exhaust pipe 181 and the muffler 182 extend substantially longitudinally from the engine 111 to the rear of the ATV 100. A muffler insulation endcover 183 and a tail pipe 184 are mounted on the muffler 182. The exhaust pipe 181 and the tail pipe 184 are in fluid communication through the muffler 182. Exhaust fumes enter the interior of the muffler 182 through the exhaust pipe 181, and noise is muffled by the muffler 182. Finally, the exhaust fumes are discharged into the external air through the tail pipe 184. The tail pipe 184 is preferably a curved structure mounted on the lower outer peripheral wall of the muffler 182. Compared to arranging the tail pipe 184 on the rear end of the muffler 182, locating the tail pipe 184 on the peripheral wall of the muffler 182 can increase the longitudinal length of the tail pipe 184, thereby decreasing the volume of the muffler 182.

The center of the connection between the tail pipe 184 and the muffler 182 is defined as a tailpipe connection position. The longitudinal distance between the tailpipe connection position and the tail end of the muffler 182 is defined as an additional tailpipe length distance h. A ratio h/H of the additional tailpipe length distance h to the total length H of the muffler 182 is in the range from 0.1 to 0.2. This can receive exhaust fumes that have been sufficiently silenced by the muffler 182, and can also make space for installation of other components of the ATV 100, while simultaneously reducing the temperature impact of discharged fumes on other components of the ATV 100.

As shown in FIG. 43, the muffler insulation endcover 183 is mounted on the rear end of the muffler 182 away from the exhaust pipe 181. The muffler insulation endcover 183 includes a decorative layer 1831 and an insulation layer 1832. The decorative layer 1831 can come into contact with external air, and the insulation layer 1832 is positioned between the decorative layer 1831 and the muffler 182. The insulation layer 1832 helps isolate the heat conducted by the muffler 182. In order to isolate as much heat as possible from the muffler 182, the thickness of the insulation layer 1832 is greater than that of the decorative layer 1831. More preferably, the thickness of the insulation layer 1832 is at least twice that of the decorative layer 1831. The insulation layer 1832 preferably uses composite materials, which have better insulation effects compared to metals. Both the cross-section of the muffler 182 and the shape of the muffler insulation endcover 183 are preferably circular, with the diameter of the insulation layer 1832 greater than the diameter of the tail end of the muffler 182, and the diameter of the decorative layer 1831 greater than the diameter of the insulation layer 1832. The muffler insulation endcover 183 may alternatively be of other shapes to match the shape of the muffler.

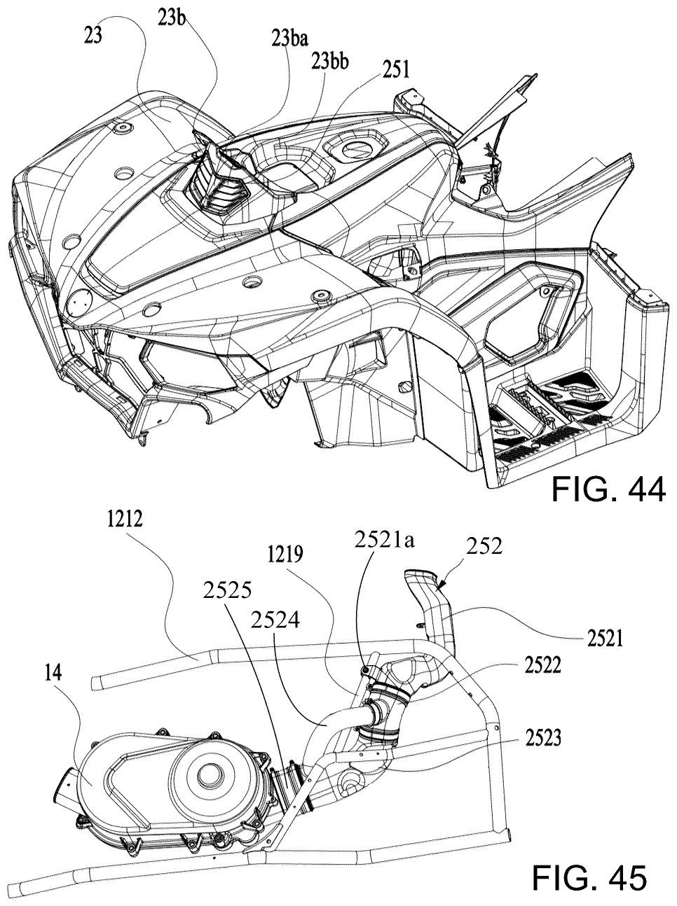

The intake system 25 is used to deliver clean, dry, sufficient, and stable air to the prime mover assembly 11, including air for combustion and air for cooling. As shown in FIGS. 44 and 45, the intake system 25 includes an air inlet 251 and at least one air intake pipe 252. The vehicle cover 23 includes an instrument shield 23b best shown in FIGS. 44 and 55. The air inlet 251 is at least partially defined on the instrument shield 23b. The instrument shield 23b has a windward surface 23ba which extends transversely. The windward surface 23ba preferably includes a left windward surface and a right windward surface, symmetrical relative to the longitudinal mid-plane 303 of the ATV 100. The length of the instrument shield 23b in the front-rear direction of the ATV 100 is reduced, thereby making the structure of the ATV 100 more compact, improving the space utilization rate of the ATV 100, and improving the driving operability of the ATV 100.

At least one air inlet 251 is defined on the windward surface 23ba of the instrument shield 23b. Air enters the interior of the instrument shield 23b through the air inlet 251, thereby allowing the ambient air to flow towards the intake pipe 252. The air inlet 251 is preferably covered by a grille 23bb with a plurality of louvers to prevent leaves and similar large debris from entering the air inlet 251. The grille 23bb slopes upwardly and rearwardly at a windward air inlet angle η (called out in FIG. 55) which is preferably in the range from 45 degrees to 90 degrees to horizontal, and more preferably in the range from 50 degrees to 80 degrees to horizontal. The arrangement of the louvers on the grille 23bb can also prevent precipitation water and other liquids from flowing towards the back of the instrument shield 23b and entering the interior of the instrument shield 23b, thereby improving the service life of the ATV 100. The louvers preferably extend upwardly and rearwardly at a louver angle in the range from 9 degrees to 11 degrees above horizontal, and most preferably 10 degrees above horizontal. The amount of air entering the instrument shield 23b can meet requirements for the air intake system 25.

FIG. 45 shows the preferred intake pipe 252 for delivering cooling air to the transmission 14. The intake pipe 252 includes an initial intake pipe segment 2521, an airflow separation pipe joint 2522, a main branch intake pipe segment 2523, a supplemental branch intake pipe segment 2524, and an airflow conjunction pipe joint 2525. The three pipe segments 2521, 2523, 2524 are hollow annular structures such as formed of molded plastic. The two pipe joints 2522, 2525 are formed of a more resilient, elastic material such as rubber. The shaking of intake pipe 252 can be reduced by utilizing the elastic material for the pipe joints 2522, 2525 to absorb the swinging force of intake pipe 252 during the driving or movement of ATV 100. Hose clamps can be used to tighten connections between the pipe segments 2521, 2523, 2524 and the pipe joints 2522, 2525.

Ambient air enters the instrument shield 23b from the air inlet 251, and then flows through the initial intake pipe segment 2521 to the airflow separation pipe joint 2522. In the airflow separation pipe joint 2522, the air flow splits into a main stream and a supplemental stream. The main stream flows through the main branch intake pipe segment 2523 to the airflow conjunction pipe joint 2525, while the supplemental stream flows through the supplemental branch intake pipe segment 2524 to the airflow conjunction pipe joint 2525. The inner diameter of the main branch intake pipe segment 2523 is larger than that of the supplemental branch intake pipe segment 2524. The two air streams combine in the airflow conjunction pipe joint 2525, which delivers cooling air into the transmission 14. The intake pipe 252 utilizes a bifurcated intake pipe design to increase the area of the intake pipe 252 while working around other components of the ATV 100, thereby effectively improving the intake air volume of the intake pipe 252, solving the problem of insufficient intake volume, improving the intake efficiency, and achieving better heat dissipation from the transmission 14. At the same time, the intake pipe 252 fully utilizes the internal space of the ATV 100 to improve space utilization. To support the transmission cooling intake pipe 252, the initial intake pipe segment 2521 is connected to the two front angled support beams 1219 by a bolted hanger 2521a.

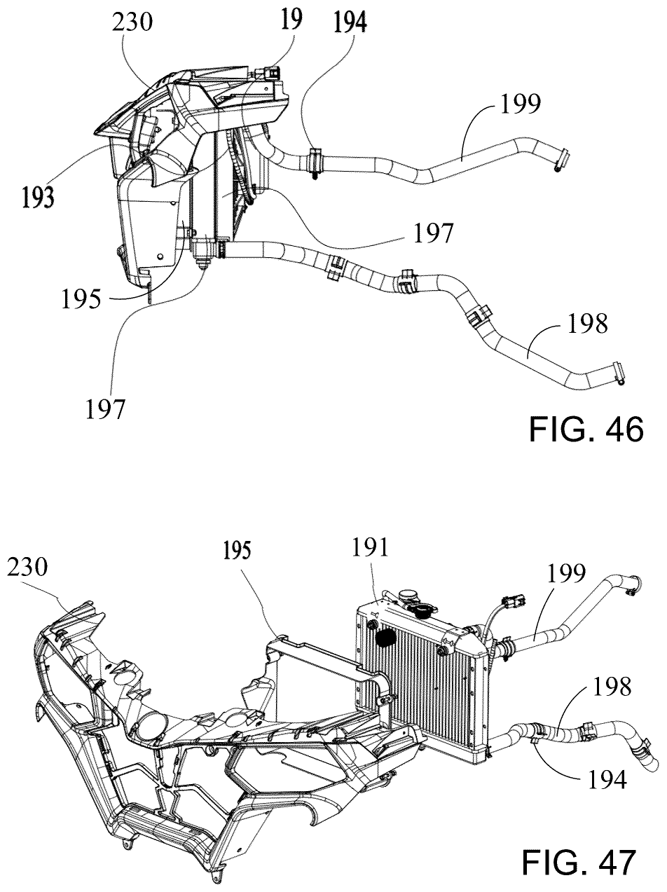

The engine 111 is the power source for the entire ATV 100. Heat generated by the engine 111 during operation is very large, and gas temperature around the engine 111 during operation generally reaches the range from 600° C. to 800° C. To prevent internal components of the ATV 100 from malfunctioning due to high temperature, it is necessary to cool down the prime mover assembly 11. The ATV 100 further includes a cooling system 19, which can timely remove heat from inside the engine 111 and allow the engine 111 to operate at the most suitable temperature. As shown in FIGS. 46-50, the cooling system 19 preferably includes a radiator 191, a coolant overflow tank 192, a wind deflector shroud 195, a radiator fan 197, a coolant output hose 198 and a coolant return hose 199.

The wind deflector shroud 195 is mounted on the front side of the radiator 191, between the radiator 191 and the vehicle cover 23. The wind deflector shroud 195 defines an air guide cavity at the front, air input side of the radiator 191. The air deflector shroud 195 is mounted on the radiator 191 such as by means of bolts (not shown). While the ATV 100 is moving, the wind deflector shroud 195 channels air received through the front of the vehicle cover 23 into and through the radiator 191, effectively improving intake efficiency. More importantly, while the ATV 100 is stationary but the engine 111 is running, the wind deflector shroud 195 helps to prevent hot air discharged from the radiator fan 197 from being sucked back into the wind-in front surface of the radiator 191. The wind deflector shroud 195 can effectively block the reflux of hot air, improving the heat dissipation effect of the radiator 191, and reducing the engine temperature.

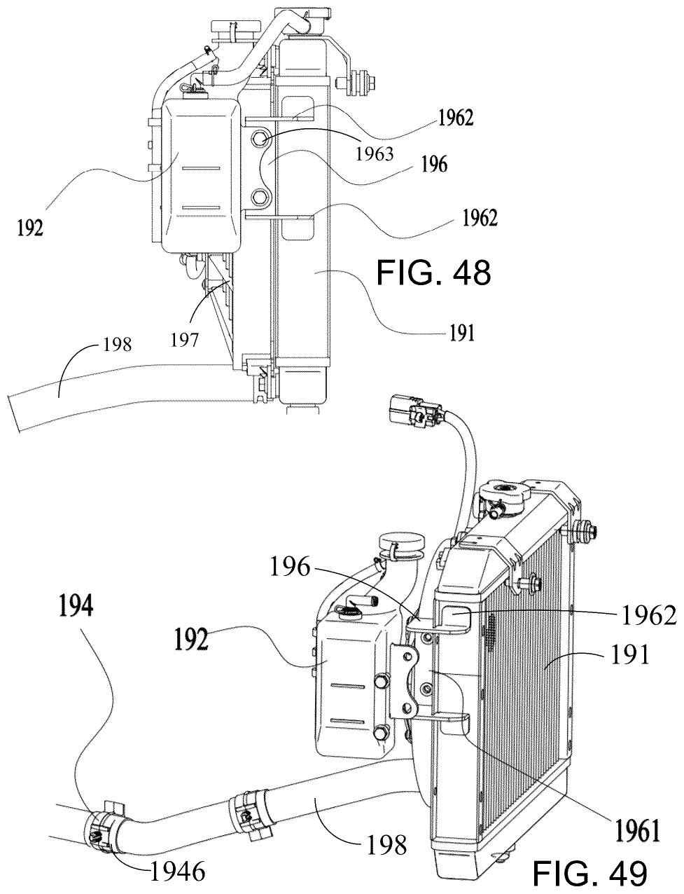

As shown in FIGS. 48 and 49, an overflow tank mount bracket 196 for installing coolant overflow tank 192 is arranged on one side of the radiator 191, which in the preferred embodiment is the left side. The overflow tank mount bracket 196 has two weld flanges 1962 and provides a vertically and longitudinally extending attachment surface 1961 behind the radiator 191. The vertically extending attachment surface 1961 is preferably integrally formed with the two weld flanges 1962. The overflow tank mount bracket 196 is fixed to the radiator 191 such as by welding the weld flanges 1962 to the side of the radiator 191. The coolant overflow tank 192 is connected to the attachment surface 1961 of the overflow tank mount bracket 196 by bolts 1963, thereby making it easy to disassemble and install the coolant overflow tank 192. The overflow tank mount bracket 196 solves the installation problem of the coolant overflow tank 192, thereby reducing assembly labor and material costs, while also minimizing installation space of the coolant overflow tank 192.

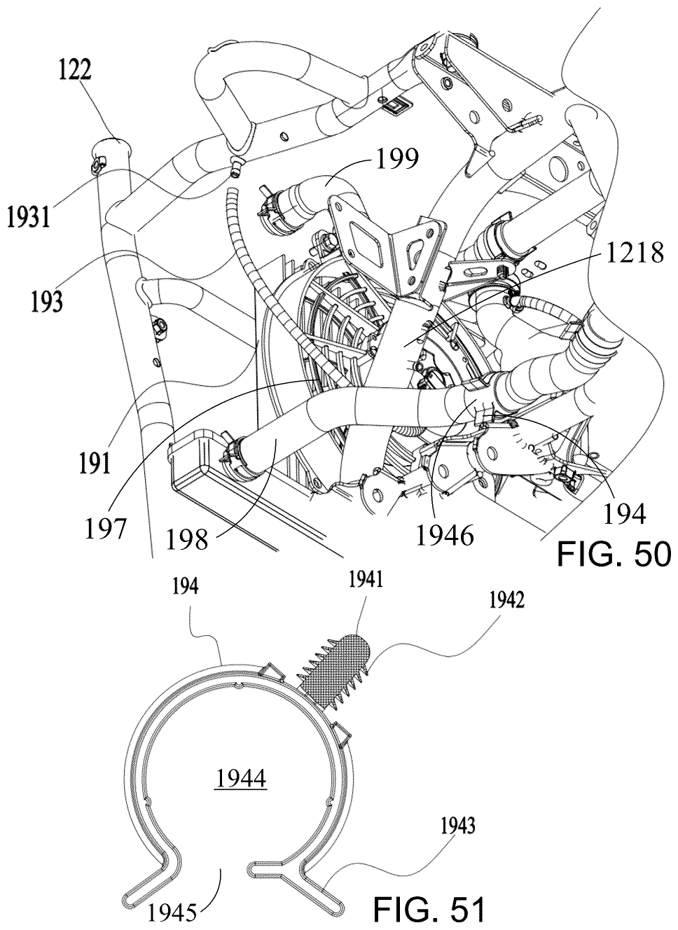

The cooling system 19 includes a fan vent pipe 193 shown in FIGS. 46 and 50. The fan vent pipe 193 is positioned behind the radiator 191, and is connected to the front brace 122. Due to the small diameter of fan vent pipe 193, it is prone to water ingress or blockage caused by mud and sand. Therefore, the installation position and exhaust direction of the fan vent pipe 193 are particularly important.

The fan vent pipe 193 is mounted on the front brace 122 by a connector 1931, which is a hollow structure. One end of connector 1931 is connected to the front brace 122, and the other end of connector 1931 is in an interference fit with the fan vent pipe 193. Ventilation holes and/or weight reduction holes defined on the front brace 122 are used to exhaust hot air to the external environment, so the exhaust air path of the fan vent pipe 193 are not be considered and limited, which can solve the installation problem of the fan vent pipe 193. The installation cost can be reduced while effectively avoiding mud, water, and the like from entering the fan vent pipe 193 and affecting the performance of the radiator 191.

Either or both of the coolant output hose 198 or coolant return hose 199 of the cooling system 19 can be fixed to the frame 12 by using one or more of a hose support clamp 194 best shown in FIG. 51. The hose support clamp 194 defines an installation space 1944 for fixing the coolant hose 198, 199, and the cross-sectional area of the installation space 1944 is substantially circular. The diameter of the cross-sectional area of the installation space 1944 is slightly smaller than the diameter of the coolant hose 198, 199, so that the hose support clamp 194 is in an interference fit with the coolant hose 198, 199, thereby achieving fixation between the hose support clamp 194 and the coolant hose 198, 199. A rivet clip 1941 is arranged on the outer wall of the hose support clamp 194, and at least one fin 1942 is arranged on the rivet clip 1941. The hose support clamp 194 is connected to the frame 12 by pushing the rivet clip 1941 into a hole on the frame 12, with the fin(s) 1942 holding the rivet clip 1941 to the frame 12. The rivet clip 1941 can prevent the hose support clamp 194 from falling off and has a good fixing effect. The angle defined between the outer plane of the rivet clip 1941 and the fin(s) 1942 is in the range from 0 degree to 90 degrees. Multiple pairs of the fins 1942 can be substantially symmetrically mounted on the rivet clip 1941, which provides better anti reverse effect and makes the connection between the hose support clamp 194 and the frame 12 more stable and reliable.

The hose support clamp 194 has flipped edge structures 1943 which define an opening 1945 connected to the installation space 1944. The flipped edge structures 1943 facilitate manual installation by allowing hand expansion of the opening 1945 of the hose support clamp 194, thereby making it easier for assembly workers to connect the coolant hose 198, 199 with the hose support clamp 194. A protective sheath 1946 (shown in FIG. 50) can be mounted on the coolant hose 198, 199 corresponding to the installation position of the hose support clamp 194. The outer diameter of the protective sheath 1946 should be greater than the diameter of the installation space 1944. The protective sheath 1946 is fixed and matched with the hose support clamp 194 to reduce the wear of the coolant hose 198, 199 and have the function of indicating the installation position. When installing, it is only necessary to determine whether the position of the hose support clamp 194 corresponds to the position of the protective sheath 1946 to determine whether there is an error in the installation of the coolant hose 198, 199. The protective sheath 1946 is preferably made of polyethylene material and mounted on the coolant hose 198, 199 through a heat shrink process. The hose support clamp 194 is preferably made of plastic, which is beneficial for cost control. The fixing of the coolant hoses 198, 199 is achieved through the use of the hose support clamps 194, which effectively reduces manual assembly costs and assembly difficulties.

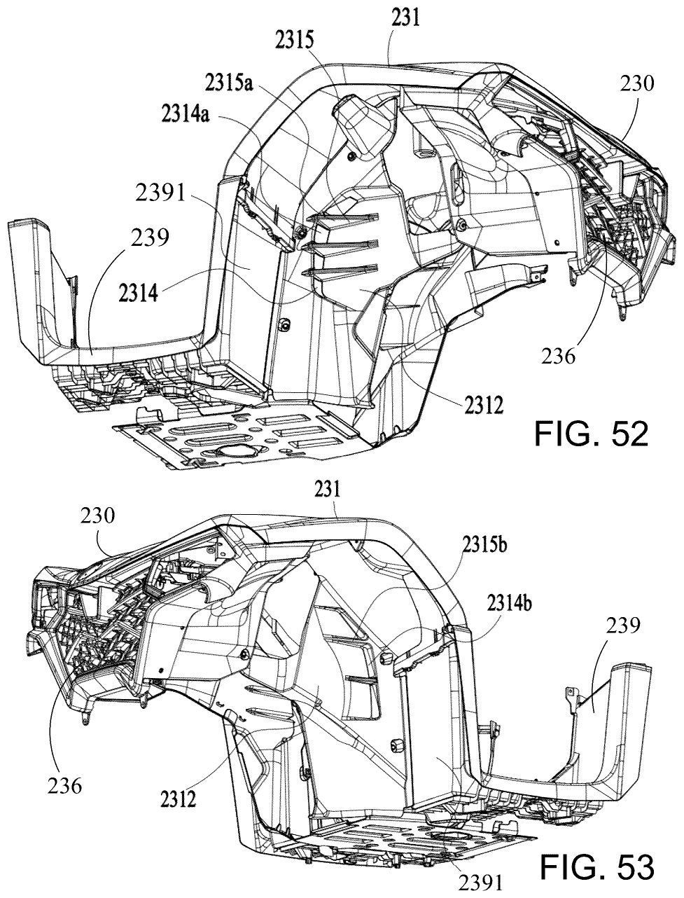

The vehicle cover 23 includes two front fenders 231 and two rear fenders 232 used to prevent the wheels 26 from throwing soil into the interior of the ATV 100 or onto the user. Footwells 239 are positioned between the front fenders 231 and the rear fenders 232. Undersides of the front fenders 231 and footwells 239 as well as a front nosepiece 230 and front grille 236 are shown in FIGS. 52 and 53. The footwells 239 each provide a footwell windward surface 2391 adjacent to the rear end of the front wheel 261 that comes into contact with ambient air entering from the front end of the ATV 100 while driving. A fender wind-in surface 2312 is connected to the footwell windward surface 2391 and is positioned on the inside of the front wheel 261. Each fender wind-in surface 2312 has one or more flow-guiding plates 2315 defining one or more flow-guiding cavities 2314 which are ventilation holes through the material of the front fenders 231. As can be seen by the differences shown between FIGS. 52 and 53, the right flow-guiding plates 2315a may differ in shape and/or number from the left flow-guiding plates 2315b, and the right flow-guiding cavities 2314a may differ in shape and/or number from the left flow-guiding cavities 2314b.

The flow-guiding cavities 2314 are used to guide ambient air from the windward surface 2391 into the accommodation space 23a (see FIG. 1) on the interior of the ATV 100, thereby reducing the internal temperature of the ATV 100. The total area of the right flow-guiding cavities 2314a and the total area of the left flow-guiding cavities 2314b are preferably both in the range from 5800 mm² to 9000 mm². During running of the ATV 100, ambient air continuously converges on the footwell windward surface 2391, and air pressure on the footwell windward surface 2391 increases with vehicle speed. Air pressure on the fender wind-in surface 2312 is low, forming a pressure difference. Ambient air flows from the high pressure area to the low pressure area, that is, from the footwell windward surface 2391 to the fender wind-in surface 2312, and is introduced into the accommodation space 23a in the interior of the vehicle 100 through the flow-guiding cavities 2314. Airflow inside the ATV 100 through the accommodation space 23a underneath the vehicle cover 23 is increased, thereby significantly reducing the temperature inside the ATV 100 and improving riding comfort. The flow-guiding cavities 2314 thus improve the heat dissipation effect of the vehicle cover 23, thereby enhancing the service life and improving the comfort of the ATV 100.

The flow-guiding plates 2315 preferably extend horizontally to divide the flow-guiding cavities 2314. During running of the ATV 100, the flow-guiding plates 2315 can increase the intake volume of the flow-guiding cavities 2314, thereby increasing the amount of air introduced into the interior of the ATV 100. The flow-guiding plates 2315 can also block mud and water from entering the flow-guiding cavities 2314, helping to prevent blockage of the flow-guiding cavities 2314 and helping to retain intake efficiency.

The elevation and size of the flow-guiding cavities 2314 may be adjusted according to the arrangement of the exhaust system 18. For example, when the exhaust system 18 is mounted on the right side of ATV 100, the area of the right flow-guiding cavities 2314a may be greater than the area of the left flow-guiding cavities 2314b, thereby allowing more air to cool the exhaust system 18. If the exhaust system 18 is conversely mounted on the left side of ATV 100, the converse relationships apply. Alternatively, the area of the right flow-guiding cavities 2314a may be equal to that of the left flow-guiding cavities 2314b without regard to which side the exhaust system 18 is mounted on. On either side, the elevation of the flow-guiding cavities 2314 is preferably substantially the same height as the majority of the exhaust system 18. The exhaust system 18 releases significant heat during running of the ATV 100, and airflow through the flow-guiding cavities 2314 can substantially cover the exhaust system 18, thereby increasing the service life of the exhaust system 18 and improving the heat dissipation effect of the ATV 100.

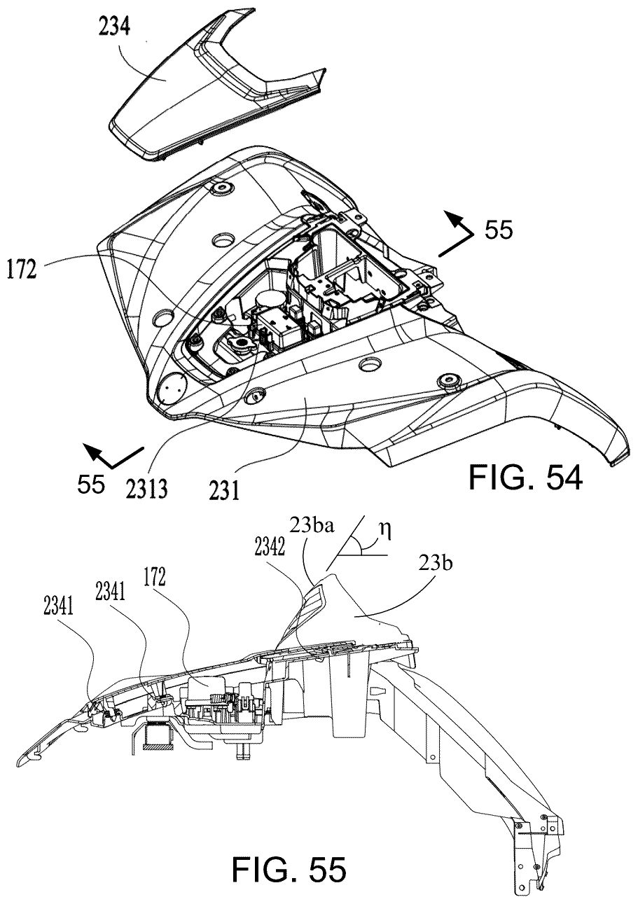

As shown in FIG. 54 and FIG. 55, the preferred vehicle cover 23 includes a front maintenance cover 234 which covers a front maintenance chamber 2313 positioned between the front fenders 231. Devices that require frequent inspection, repair, or replacement in the vehicle, such as fuses in a fuse box 172, automatic oil cups, fuses, relays, waterproof plugs, and others can be positioned in the front maintenance chamber 2313, which facilitates the inspection of component losses and replacement, saving maintenance time and thus reducing labor costs. The front maintenance cover 234 helps keep the front maintenance chamber 2313 waterproof and dust-proof, thereby ensuring the service life of the components inside the front maintenance chamber 2313.

The front maintenance cover 234 is connected to one or both front fenders 231 by a connection portion such as one or two hooks 2341 opposite a clamping portion 2342. The hooks 2341 and the clamping portion 2342 can limit the movement of the front maintenance cover 234. The front maintenance cover 234 preferably has a clearance fit relative to the front fenders 231, thereby leaving a gap space for manual grip. The user can insert fingers into the gap space to push the hooks 2341 out of engagement and then lift the front maintenance cover 234 out of the way to gain access to the front maintenance chamber 2313. When repairing the front maintenance chamber 2313 or any components therein, disassembly and assembly of the front maintenance cover 234 can be completed without the use of tools, which is simpler, has better re-usability and is more convenient and faster.

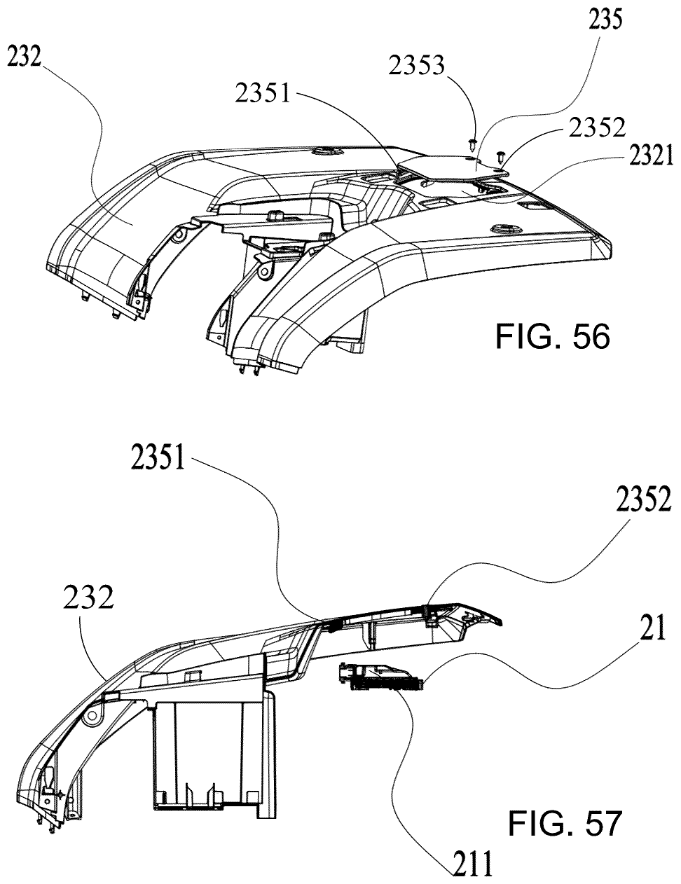

The ATV 100 further includes a control system 21, which includes an ECU (Electronic Control Unit) 211. The ECU 211 is electrically connected to the engine 111 and can control the ignition and starting of the engine 111. Generally, the working temperature of the ECU 211 is between −40° C. and 80° C. The ECU 211 cannot withstand higher temperatures and should be kept away from heat sources, and contact with water can easily lead to water damage. As shown in FIGS. 56, and 57, the ECU 211 is mounted in a rear maintenance chamber 2321 positioned between the rear fenders 232 and covered by a rear maintenance cover 235. The rear maintenance chamber 2321 is thus far away from the prime mover assembly 11 and as far above the wheels 26 as possible. The rear maintenance cover 235 can prevent water from entering the rear maintenance chamber 2321 even when the ATV 100 wades through water, preventing damage to ECU 211 caused by water immersion. The rear maintenance cover 235 includes attachment tabs 2351 on one edge and bolt holes 2352 on an edge opposing the attachment tabs 2351. The attachment tabs 2351 can be clamped under edges of the rear fenders 232 to limit vertical movement of the rear maintenance cover 235, while the bolt holes 2352 are used to detachably fix the rear maintenance cover 235 to the rear fenders 232 by bolts 2353. The attachment tabs 2351 and bolts 2353 reduce the difficulty of disassembling and assembling the rear maintenance cover 235, making it easier for users to open. At the same time, the ECU 211 is kept in a safe environment and is easy to maintain.

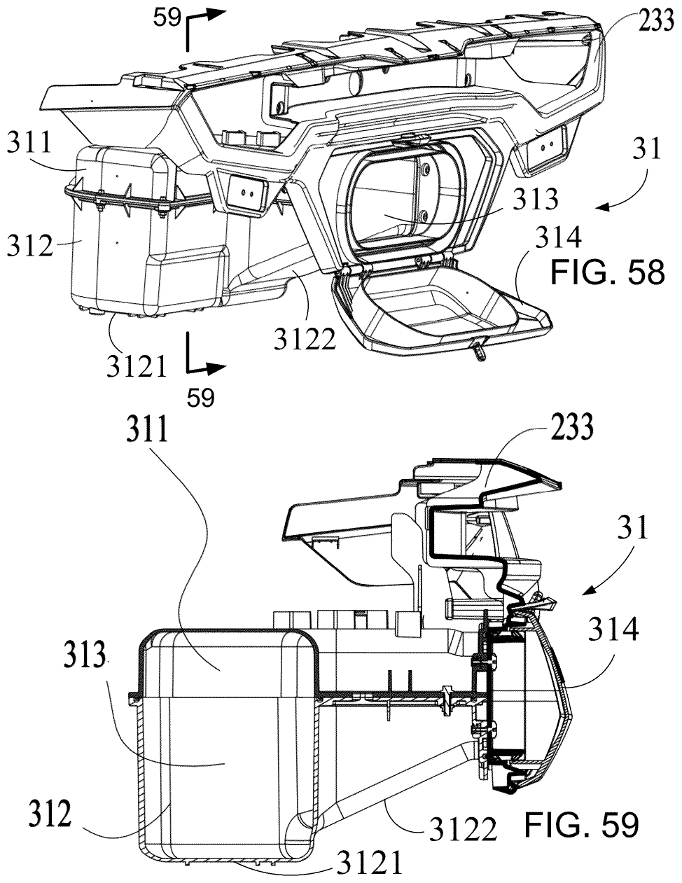

In existing technology, some ATVs have a trunk which has too little volume to store much, thereby making it inconvenient to use. Usually, the trunk is integrated with a trunk panel, which is not easy to disassemble and is quite disappointing for users. As shown in FIGS. 58 and 59, the ATV 100 further includes a trunk compartment 31 positioned under a tail panel 233 of the vehicle cover 23 at the rear of the ATV 100. The tail panel 233 is mounted on the rear fenders 232. A trunk door 314 extends vertically and transversely on the back of the ATV 100. The trunk door 314 is hinged at its bottom to provide access to the interior storage chamber 313 of the trunk compartment 31. The trunk door 314 is preferably positioned centered right-to-left, i.e., bisected by the longitudinal mid-plane 303. The interior storage chamber 313 however is positioned with a majority of its volume on one side (the left side as shown) of the ATV 100, leaving room for and avoiding obstruction of the muffler 182 and tailpipe 184 (shown in FIGS. 42 and 43) on the other side of the ATV 100.

As shown in FIG. 59, the trunk 31 includes a upper trunk shell 311 and a lower trunk shell 312. The upper trunk shell 311 is detachably fixed to the lower trunk shell 312 such as by bolts. A sealing ring or gasket (not shown) is placed between the upper trunk shell 311 and the lower trunk shell 312 to provide waterproof sealing between the upper trunk shell 311 and the lower trunk shell 312. Alternatively, the upper trunk shell 311 may be integrally formed with the lower trunk shell 312.

The lower trunk shell 312 preferably includes a front horizontal floor portion 3121 and a rear inclined floor portion 3122 that extends upwardly and rearwardly from the front horizontal floor portion 3121 to the bottom of the trunk door 314. The angle of the rear inclined floor portion 3122 can be selected according to the space available at the rear of the ATV. The rear inclined floor portion 3122 allows the front of the interior storage chamber 313 to have greater height and therefore greater volume, while still facilitating the user's access to items place in the trunk compartment 31. The user has a broad operating field of view when looking through the open trunk door 314 to clearly see the situation inside the interior storage chamber 313. Compared to trunk structures in existing technology, the preferred trunk compartment 31 is convenient for the user to install and remove during maintenance while at the same time providing larger storage space for stable object storage, and convenient access.

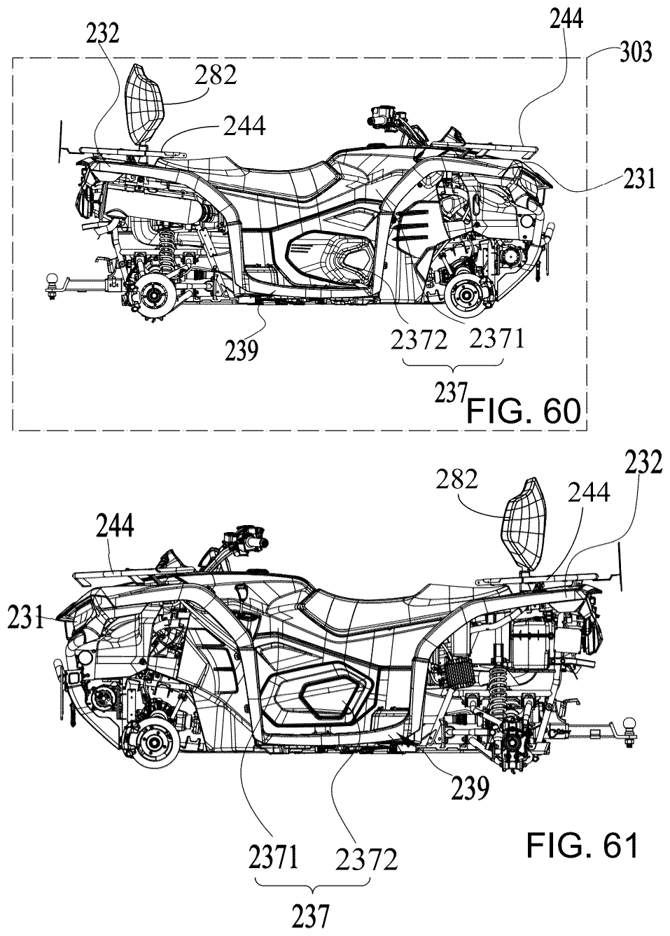

As shown in FIGS. 60 and 61, the vehicle cover 23 further includes left and right side cover assemblies 237. Each side cover assembly 237 provides a generally vertical, longitudinally extending surface within and above the respective left and right footwell 239. Each footwell 239 is connected between the respective left and right front fender 231 and the respective left and right rear fender 232. Though right and left sides may vary in details, the footwells 239 and the side cover assemblies 237 are substantially symmetrical with respect to the longitudinal mid-plane 303.

Each side cover assembly 237 includes a side cover 2371 above an insulation cover 2372. The side covers 2371 are clamped to the front saddle mounting bracket 241 (shown in FIGS. 5 and 6). The left and right side covers 2371 are connected to the respective left and right rear fenders 232 by means of clearance fit, which leaves a gap space on both sides of the ATV 100 that can be held by human hands for easy installation and disassembly. Tool-free disassembly and assembly is simple, fast, and easy to maintain, improving maintenance efficiency and reducing time costs. Bottom ends of the left and right side covers 2371 are clamped and fixed with top ends of the respective insulation covers 2372. Due to the close contact between the side covers 2371 and the human body, overheating of the side covers 2371 can cause discomfort to the user. Therefore, an insulation board (not shown) can be mounted on the insides of the side covers 2371 to isolate heat. The insulation board may be made of multi-layer composite materials, for example, may be made of aluminum foil and ceramic fibers.

Each insulation cover 2372 is mounted on a straddle portion on the side of engine 111. The straddle portion refers to the portion of the ATV 100 positioned adjacent to the inner legs when the user drives the ATV 100. The accommodation space 23a inside the ATV 100 extends from the front of frame 12, runs inside of the left and right insulation covers 2372 and extends to the rear of frame 12. The prime mover assembly 11 is preferably substantially isolated from contact with the left and right insulation covers 2372 by airflow within the accommodation space 23a. The amount of airflow within the accommodation space 23a can be increased by increasing the distance between the prime mover assembly 11 and the left and right insulation covers 2372. The airflow within the accommodation space 23a effectively reduces the temperature of the insulation covers 2372 in contact with the user's legs, improving driving comfort.

As shown in FIGS. 62 and 63, each insulation cover 2372 includes a readily detachable sideplate 2372a centered in a peripheral portion 2372b. The peripheral portion 2372b of the insulation cover 2372 is fixedly connected to the footwell 239 and to the front and rear fenders 231, 232 such as by bolts, screws or rivet clips 2373. The sideplate 2372a is positioned within the peripheral portion 2372b so as to be accessible from outside of the ATV 100. The sideplate 2372a is clamped onto the peripheral portion 2372b of the insulation cover 2372 so as to form a gripping portion such as a groove or recess. During maintenance, the sideplate 2372a can be disassembled by hand through the gripping portion, conveniently and without the need for tools, saving time and cost. The width of the gripping portion is greater than the width of the human finger. Specifically, the width of the gripping portion can be set to be greater than or equal to 1 cm to ensure that the human finger can enter the gripping portion, so that the sideplate 2372a can be disassembled by hand through the gripping portion without any tools. To ensure good operation of the ATV 100, frequent inspection/maintenance of the components of the prime mover assembly 11 is required. The sideplate 2372a is positioned on the side of the prime mover assembly 11, and the hand disassembly of the sideplate 2372a shortens the inspection/maintenance time of prime mover assembly 11 including the engine 111.

One or both of the insulation covers 2372 includes an insulation strip 2374 shown in FIG. 63. The insulation strip 2374 may be made of materials including aluminum foil and ceramic fibers. The insulation strip 2374 helps to prevent lateral heat flow, thereby making heat dissipate inside the ATV 100 more quickly from front to rear through the accommodation space 23a, which effectively improves the ventilation efficiency inside the ATV 100. The insulation strip 2374 can also effectively reduce the noise of the engine 111 during starting or driving the ATV 100.

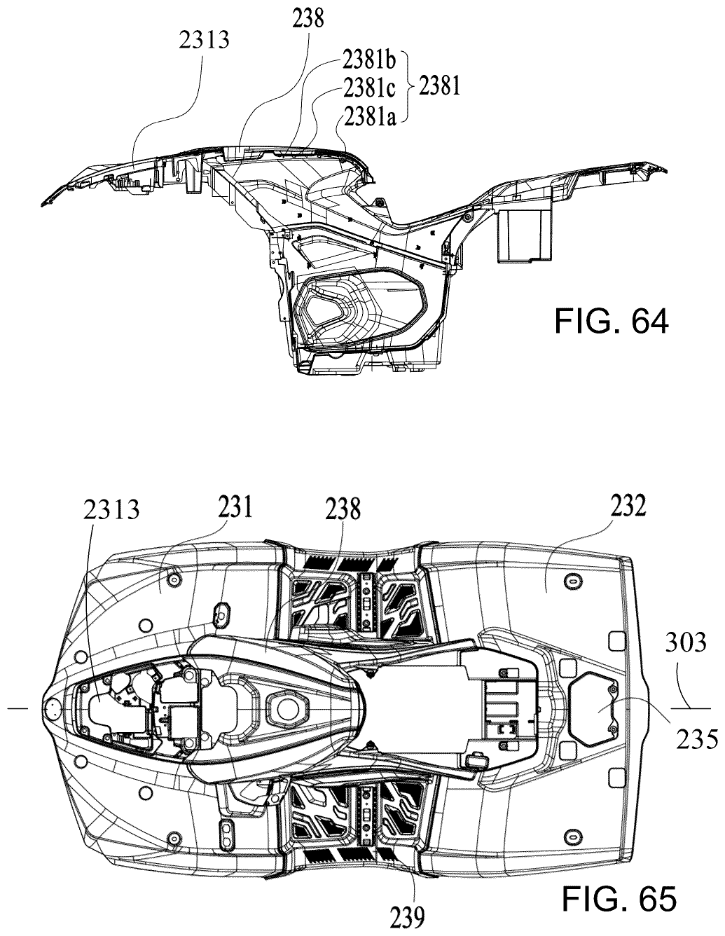

The vehicle cover 23 further includes a fuel tank guard 238 discussed with reference to FIGS. 64 and 65. The fuel tank guard 238 is mounted above the fuel tank 132, and is used to protect the fuel tank 132. The fuel tank guard 238 is connected to the front fenders 231 and to the side cover assemblies 237 by one or more fixing portions 2381. Each fixing portion 2381 includes a bolt fixing end 2381a, a clamp end 2381b, and a plug hole 2381c. The bolt fixing end 2381a includes a front bolt fixing end and a rear bolt fixing end. The bolt fixing end 2381a enables the fuel tank guard 238 to be connected to the side cover 2371 by bolts. A spatial range is defined between the front bolt fixing end and the rear bolt fixing end, and the clamp end 2381b and the plug hole 2381c are arranged in intervals within this spatial range. The clamp end 2381b can be clamped and matched with the side cover 2371 to limit vertical movement of the fuel tank guard 238. The plug hole 2381c can also be connected to the side cover 2371. The clamp fitting is used to limit longitudinal and transverse movement of the fuel tank guard 238, thereby achieving the connection between the side cover 2371 and the fuel tank guard 238. This can reduce the assembly process, improve assembly efficiency, and facilitate integrated disassembly and installation by connecting and fixing the fuel tank guard 238, the front fenders 231 and the side covers 2371, and then assembling them onto the ATV 100.

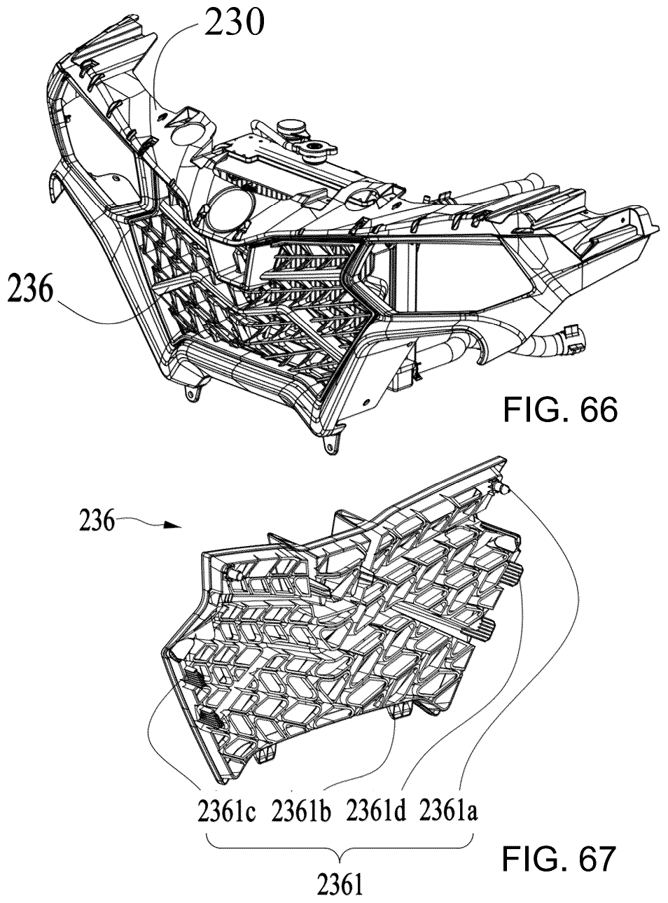

The preferred vehicle cover 23 further includes a front grille 236 shown in FIGS. 66 and 67. The front grille 236 defines a plurality of grid-shaped ventilation holes, which allow ambient air to be introduced to the vehicle interior through the front grille 236. The front grille 236 is positioned in the front of the ATV 100, and is mounted on the front nosepiece 230. Connection clips 2361 for connecting the front grille 236 to the front nosepiece 230 are arranged on the inner side of the front grille 236. The connection clips 2361 preferably include one or more upper connection clips 2361a, one or more lower connection clips 2361b, one or more left connection clips 2361c, and one or more right connection clips 2361d. The connection clips 2361 limit the movement of the front grille 236 in all directions, making the installation of the front grille 236 more firm and reliable. The connection clips 2361 are detachable, simplifying the disassembly and assembly process. As ATVs generally operate in outdoor environments, weeds, leaves, and other garbage can easily accumulate on the front grille 236 when driving. In some existing ATVs, the front grille and the nosepiece are integrated, which increases the time, labor and difficulty of cleaning the garbage in the front grille. With the connection clip design, users can disassemble and assemble the preferred front grille 236 from the front nosepiece 230 without using tools, making it easy to clean.

Although preferred embodiments of this embodiment have been disclosed for illustrative purposes, those skilled in the art will recognize that various improvements, additions, and substitutions are possible without departing from the scope and spirit of this embodiment disclosed by the accompanying claims.

1. An all-terrain vehicle comprising:
a frame;
a vehicle cover at least partially arranged on the frame, the vehicle cover defining an accommodation space and comprising an instrument shield;
a plurality of wheels comprising two front wheels and two rear wheels;
a suspension comprising a front suspension and a rear suspension, the front wheels being connected to the frame by the front suspension and the rear wheels being connected to the frame by the rear suspension;
a prime mover assembly for driving the wheels and comprising an engine, the prime mover assembly being supported by the frame in the accommodation space;
a transmission coupled between the engine and the wheels, torque being passed from the engine to the wheels by the transmission; and
an air intake system in fluid communication with the prime mover assembly, the intake system comprising:
an air inlet at least partially defined on the instrument shield; and
an air intake pipe connected to the transmission, the air inlet being in fluid communication with the air intake pipe;
wherein the vehicle cover comprises a left cover assembly with a left insulation cover and a right cover assembly with a right insulation cover, with the accommodation space extending inside of the left and right insulation covers from a front of frame to a rear of frame, with the prime mover assembly being substantially isolated from contact with the left and right insulation covers by airflow within the accommodation space.

2. The all-terrain vehicle of claim 1, wherein the air intake pipe comprises an airflow separation pipe joint, a main branch intake pipe segment, a supplemental branch pipe segment and an airflow conjunction pipe joint, wherein airflow from the air inlet separates into a main flow through the main branch intake pipe segment and a supplemental flow through the supplemental branch pipe segment before being recombined in the airflow conjunction pipe joint and provided to the transmission.

3. The all-terrain vehicle of claim 1, wherein the instrument shield has a windward surface facing forwardly, the air inlet being at least partially defined on the windward surface.

4. The all-terrain vehicle of claim 3, wherein the instrument shield windward surface is covered by a grille with a plurality of louvers that divide the instrument shield windward surface, and wherein the grille slopes upwardly and rearwardly at a windward air inlet angle in the range from 45 degrees to 90 degrees to horizontal.

5. The all-terrain vehicle of claim 4, wherein each of the plurality of louvers extend upwardly and rearwardly at a louver angle in the range from 9 degrees to 11 degrees above horizontal.

6. The all-terrain vehicle of claim 1, wherein the vehicle cover further comprises a front fender with at least one flow-guiding cavity defined on an underside of the front fender providing at least one ventilation hole in fluid communication with the accommodation space.

7. The all-terrain vehicle of claim 6, wherein the vehicle cover has a footwell with a footwell windward surface facing forwardly under the front fender and behind the flow-guiding cavity, the footwell windward surface increasing airflow into the flow-guiding cavity.

8. The all-terrain vehicle of claim 7, wherein the front fender has a fender wind-in surface extending substantially vertically and longitudinally and coupled to the footwell windward surface, wherein the flow-guiding cavity is at least partially defined on the fender wind-in surface.

9. The all-terrain vehicle of claim 8, wherein a plurality of the flow-guiding cavities on a right or left side of the all-terrain vehicle have a total area in the range from 5800 mm² to 9000 mm².

10. The all-terrain vehicle of claim 9, wherein a plurality of flow-guiding plates divide airflow into the plurality of flow-guiding cavities.

11. The all-terrain vehicle of claim 1, wherein the vehicle cover further comprises two front fenders, two rear fenders, and left and right footwells each extending from the respective front fender to the respective rear fender, wherein the left and right insulation covers are connected between the respective front fender and the respective rear fender above the respective footwell.

12. The all-terrain vehicle of claim 1, wherein an insulation strip for isolating heat of the prime mover assembly is arranged between at least one of the left and right insulation covers and the prime mover assembly.

13. The all-terrain vehicle of claim 1, wherein at least one of the left insulation cover and the right insulation cover comprises:
a peripheral portion fixed on the all-terrain vehicle; and
a readily detachable sideplate accessible from outside of the ATV and clamped onto the peripheral portion so as to be removable by hand without any tools.

14. The all-terrain vehicle of claim 1, further comprising a collection of mounting brackets arranged on the frame, the collection of mounting brackets comprising a front saddle mounting bracket, the front saddle mounting bracket having a protective hole and a limiting member for holding an ignition coil within the protective hole.

15. The all-terrain vehicle of claim 1, wherein the vehicle cover comprises a front grille arranged at the front end of the all-terrain vehicle on a front nosepiece, the front grille having a plurality of connection clips which enable the front grille to be removed from the front nosepiece by hand and without tools for cleaning of the front grille separate from the all-terrain vehicle.

16. The all-terrain vehicle of claim 1, wherein the vehicle cover comprises two front fenders with a front maintenance cover detachably mounted between the two front fenders, and two rear fenders with a rear maintenance cover detachably mounted between the two rear fenders.

17. The all-terrain vehicle of claim 1, further comprising a saddle assembly with a backrest, wherein the backrest comprises:
a supporting skeleton
a main backrest cushion supported on the supported skeleton; and
a surface cushion layer on the main backrest cushion toward the rider, the surface cushion layer being softer and thinner than the main backrest cushion.

18. The all-terrain vehicle of claim 1, wherein the engine comprises a cylinder with a cylinder head, wherein the prime mover assembly is supported on the frame by a cradle holding the gravitational weight of the prime mover assembly, and further comprising a cylinder head support mounted on the frame above the cradle.

19. An all-terrain vehicle comprising:
a frame;
a vehicle cover at least partially arranged on the frame, the vehicle cover defining an accommodation space;
a plurality of wheels comprising two front wheels and two rear wheels;
a suspension comprising a front suspension and a rear suspension, the front wheels being connected to the frame by the front suspension and the rear wheels being connected to the frame by the rear suspension;
a prime mover assembly for driving the wheels and comprising an engine, the prime mover assembly being supported by the frame in the accommodation space;
a transmission coupled between the engine and the wheels, torque being passed from the engine to the wheels by the transmission; and
an air intake system in fluid communication with the prime mover assembly;
wherein the vehicle cover comprises:
a front fender with at least one flow-guiding cavity defined on an underside of the front fender providing at least one ventilation hole in fluid communication with the accommodation space; and
a footwell with a footwell windward surface facing forwardly under the front fender and behind the flow-guiding cavity, the footwell windward surface increasing airflow into the flow-guiding cavity.

20. An all-terrain vehicle comprising:
a frame;
a vehicle cover at least partially arranged on the frame, the vehicle cover defining an accommodation space;
a plurality of wheels comprising two front wheels and two rear wheels;
a suspension comprising a front suspension and a rear suspension, the front wheels being connected to the frame by the front suspension and the rear wheels being connected to the frame by the rear suspension;
a prime mover assembly for driving the wheels and comprising an engine, the prime mover assembly being supported by the frame in the accommodation space;
a transmission coupled between the engine and the wheels, torque being passed from the engine to the wheels by the transmission; and
an air intake system in fluid communication with the prime mover assembly;
wherein the vehicle cover comprises a left cover assembly with a left insulation cover and a right cover assembly with a right insulation cover, with the accommodation space extending inside of the left and right insulation covers from a front of frame to a rear of frame, wherein at least one of the left insulation cover and the right insulation cover comprises:
a peripheral portion fixed on the all-terrain vehicle; and
a readily detachable sideplate accessible from outside of the ATV and clamped onto the peripheral portion so as to be removable by hand without any tools.
